(19) United States
(12) Patent Application Publication
(10) Pub. No.: US 2026/0189925 A1
(43) Pub. Date: Jul. 2, 2026

(54) RADIO FREQUENCY INTERFERENCE MITIGATION

(71) Applicant: Intel Corporation, Santa Clara, CA (US)

(72) Inventors: Thirunavukkarasu S, Tirunelveli (IN); Joy PODDAR, Bangalore (IN); Dong-Ho HAN, Beaverton, OR (US); Farnaz FOROUGHIAN, Hillsboro, OR (US); Karthikeyan P, Bangalore (IN)

(21) Appl. No.: 19/002,810

(22) Filed: Dec. 27, 2024

(51) Int. Cl. H04W 16/14; H04W 24/08; H04W 84/12

(52) U.S. Cl. CPC H04W 16/14; H04W 24/08; H04W 84/12

(57) ABSTRACT

An apparatus may include: a memory, and a processor configured to: determine a utilization state of a wireless communication link configured for communication within a radio frequency channel; determine an operating frequency of a radio frequency interference generating device; and instruct the radio frequency interference (RFI) generating device to adjust the operating frequency based on the utilization state of the wireless communication link.

### BACKGROUND

In radio communication networks in accordance with many radio communication technologies, such as Wireless LAN (also referred to as Wi-Fi), Bluetooth, Fourth Generation (LTE), and Fifth Generation (5G) New Radio (NR), various methods are employed to provide wireless data transfer with desired efficiency, speed, and reliability. In radio communication networks, maintaining efficient, fast, and reliable wireless data transfer is often challenged by interference, which can degrade signal quality and data throughput. Interference can arise from a variety of internal and external sources, and its impact is particularly significant in complex communication environments where multiple devices and frequency bands are active simultaneously.

One key source of interference is adjacent channel interference, where signals from neighboring frequency channels leak into the operational bandwidth of a communication device. Additionally, external environmental interference can arise from other nearby electronic equipment, industrial devices, or even natural phenomena. Another prominent source of interference is platform interference, which originates from within the communication device itself. Platform interference may be caused by various components in the device, including radio frequency interference generating devices included by the device. An example of such radio frequency interference generating devices may include a memory devices. Further examples may include microprocessors, oscillators, display drivers, and other radio frequency (RF) components, generating electromagnetic emissions that interfere with the radio transceiver's signal path associated with a wireless communication link.

### BRIEF DESCRIPTION OF THE DRAWINGS

In the drawings, like reference characters generally refer to the same parts throughout the different views. The drawings are not necessarily to scale, emphasis instead generally being placed upon illustrating the principles described herein. In the following description, various aspects are described with reference to the following drawings, in which:

FIGS. 1 and 2 depict a general network and device architecture for wireless communication;

FIG. 3 shows an illustrative example of an apparatus;

FIG. 4 shows an example of a flow diagram;

FIG. 5 shows an example of a flow diagram;

FIG. 6 shows an example of a block diagram illustrating interference management;

FIG. 7 shows an example of a method.

### DESCRIPTION

The following detailed description refers to the accompanying drawings that show, by way of illustration, exemplary details and aspects that may be practiced.

Traditional wireless communication systems may employ various techniques to enhance data throughput, reliability, and spectral efficiency. In the field of radio communication, it is common to encounter various forms of noise that can degrade the quality of received signals. Especially, addressing interference sources generally requires sophisticated interference mitigation techniques, including adaptive filtering, signal isolation, shielding, and careful component placement. Effective mitigation may allow the device to maintain performance standards, even in environments where both external and internal sources of interference are significant. Known systems may typically involve estimating noise power characteristics to mitigate the impact of noise on signal processing. These systems may often rely on predefined models or assumptions about the noise environment, which may not accurately reflect the actual conditions encountered during operation. As a result, the effectiveness of noise mitigation techniques can be limited, leading to suboptimal performance in communication devices.

To address the challenges posed by radio frequency interference (RFI), various strategies have been developed. One approach involves dynamically adjusting the operation frequency of an RFI generating device to minimize interference with active wireless communication channels. This technique can employ a mapping mechanism that correlates operation frequencies of the RFI generating device with specific communication channels, allowing the system to identify and avoid frequency settings that could interfere with active wireless communication channels. For instance, the approach may include use of pre-characterized profiles of noise associated with different operation frequencies of the RFI generating device to enable dynamic adjustments that align the operation frequency of the RFI generating device with the requirements of the active wireless communication channels. This may result in with a cost of suboptimal performance, especially in cases where the performance of the RFI generating device is affected by its operating frequency.

For example, double data rate (DDR) interfaces, commonly used in memory devices, are known to emit electromagnetic radiation. RFI, in this context, may originate from electromagnetic radiations generated by physical components of memory systems, such as dynamic random-access memory (DRAM) modules and their associated physical designs, including printed circuit boards (PCB), packaging structures (PKG), and interconnects such as connectors. These components may emit radiations due to high-speed data transfer operations, signal reflections, or impedance mismatches, which can cause electromagnetic energy to propagate unintentionally. DRAMs may be particularly prone to RFI generation because of their reliance on tightly packed circuitry and high-frequency clock signals, which can create harmonics and spurious emissions that may interfere with nearby radio frequency channels. Furthermore, the specific configurations of PCB layouts, connector routing, and packaging techniques used in DRAM implementations may cause RFI generation, especially in densely populated electronic environments where signals are susceptible to coupling and cross-talk. Effective mitigation of RFI from these sources may often require optimized physical designs, such as shielding, improved grounding, and impedance matching, to minimize unintentional radiations and ensure compliance with electromagnetic interference (EMI) standards.

This emitted radiation can couple with signal paths and antennas of the radio communication interface, such as Wi-Fi and cellular interfaces, leading to RFI and adverse impacts on wireless performance, by causing reduced data throughput, decreased wireless range, and even loss of connectivity. In an RFI mitigation technique, the DDR frequency (i.e. the operating frequency of the memory device interface) can be adjusted to avoid interference with active Wi-Fi channels. Such RFI mitigation techniques may tend to adopt overly conservative strategies, excessively protecting operation frequencies even in scenarios where the interference is minimal. Such conservative measures can lead to suboptimal performance of the RFI generating device, such as a measurable degradation in overall system efficiency, speed, or effectiveness when the RFI mitigation mechanism is active.

Additionally, the adoption of dual-radio systems, which may integrate multiple radio technologies, such as Wi-Fi and cellular capabilities, can present further challenges. Modern cellular technologies, such as 5G, can operate within frequency bands overlapping those of Wi-Fi, particularly in the 5 GHz and 6 GHz ranges. While current RFI mitigation techniques focus exclusively on Wi-Fi interference, the co-existence of multiple radio technologies and even multiple communication technologies including wired communication technologies may be considered.

Moreover, in general implementation of RFI mitigation techniques, it may be desirable to optimize the implementation of RFI mitigation through handling advanced communication scenarios, such as multi-link operation in Wi-Fi applications. In such cases, wireless communication devices may connect to multiple Wi-Fi channels or bands simultaneously. In accordance with various aspects described herein, RFI mitigation may prioritize active channels with significant traffic.

Aspects described herein may relate to the interaction and cooperation between radio frequency management for wireless communication link and performance of RFI generating devices in wireless communication devices, which may include integrating utilization metrics, which may be real-time, such as wireless interface activity and traffic load, with RFI mitigation policies. This may aim to dynamically adapt operational frequencies to minimize interference while preserving device performance, which may address multiple use cases, including scenarios where Ethernet replaces Wi-Fi for connectivity or where cellular networks can handle significant traffic in dual-radio configurations. Correspondingly, aspects may enhance user experience by facilitating stable wireless connectivity and optimal RFI generating device performance. In some examples, aspects may facilitate shared RFI mitigation policies for dual-radio systems and may prevent unnecessary RFI generating device operation frequency degradation in devices with simultaneous wired and wireless communication usage, particularly in gaming and workstation scenarios.

In some aspects, a wireless communication device may achieve an optimized balance between interference mitigation and overall system performance through integration of communication link utilization states with RFI mitigation techniques and policies. Aspects described herein may involve leveraging metrics representative of communication link activity, such as data traffic, channel usage, and/or communication interface priorities for dynamic adjustment of the operation frequency of the RFI generating device.

Such dynamic adjustment may lead to the elimination or reduction of unnecessary adjustments to the operating frequencies of RFI generating devices, by ensuring that RFI mitigation techniques are performed only in certain cases or states. For example, if a communication link is inactive or its data traffic is minimal, a controller (e.g. a processor) of the wireless communication device may avoid frequency adjustments that could otherwise degrade the performance of the RFI generating device.

Furthermore, through the support of multi-radio environments, such as those incorporating Wi-Fi and cellular networks, in dual-radio configurations, the controller may dynamically evaluate the utilization states of each communication link and prioritize interference mitigation based on the relative importance or utilization of active channels. For instance, if a cellular connection that meets certain conditions is available, the wireless communication device may deprioritize Wi-Fi-based interference mitigation to ensure optimal use of network resources. This may be particularly beneficial in wireless communication devices where multi-band or multi-link operations are common.

Moreover, aspects described herein may extend the applicability of RFI mitigation management to multi-use scenarios. For example, in gaming or workstation environments, where simultaneous Ethernet and Wi-Fi usage may be commonly employed, the wireless communication device may prevent unnecessary performance degradation by prioritizing designated tasks and ensure that RFI generating device and communication resources are allocated efficiently. In specific applications involving multi-link operation, such as those leveraging Wi-Fi standards with multiple radios, aspects described herein may allow the wireless communication device to minimize redundant frequency adjustments, to focus instead on channels that carry the majority of the data traffic.

The apparatuses and methods described herein may utilize or be related to radio communication technologies. While some examples may refer to specific radio communication technologies, the examples provided herein may be similarly applied to various other radio communication technologies, both existing and not yet formulated, particularly in cases where such radio communication technologies share similar features as disclosed regarding the following examples. Various exemplary radio communication technologies that the apparatuses and methods described herein may utilize include, but are not limited to: a Global System for Mobile Communications (“GSM”) radio communication technology, a General Packet Radio Service (“GPRS”) radio communication technology, an Enhanced Data Rates for GSM Evolution (“EDGE”) radio communication technology, and/or a Third Generation Partnership Project (“3GPP”) radio communication technology, for example Universal Mobile Telecommunications System (“UMTS”), Freedom of Multimedia Access (“FOMA”), 3GPP Long Term Evolution (“LTE”), 3GPP Long Term Evolution Advanced (“LTE Advanced”), Code division multiple access 2000 (“CDMA2000”), Cellular Digital Packet Data (“CDPD”), Mobitex, Third Generation (3G), Circuit Switched Data (“CSD”), High-Speed Circuit-Switched Data (“HSCSD”), Universal Mobile Telecommunications System (“Third Generation”) (“UMTS (3G)”), Wideband Code Division Multiple Access (Universal Mobile Telecommunications System) (“W-CDMA (UMTS)”), High Speed Packet Access (“HSPA”), High-Speed Downlink Packet Access (“HSDPA”), High-Speed Uplink Packet Access (“HSUPA”), High Speed Packet Access Plus (“HSPA+”), Universal Mobile Telecommunications System-Time-Division Duplex (“UMTS-time division duplex”), Time Division-Code Division Multiple Access (“TD-CDMA”), Time Division-Synchronous Code Division Multiple Access (“TD-CDMA”), 3rd Generation Partnership Project Release 8 (Pre-4th Generation) (“3GPP Rel. 8 (Pre-4G)”), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 13), 3GPP Rel. 14 (3rd Generation Partnership Project Release 14), 3GPP Rel. 15 (3rd Generation Partnership Project Release 15), 3GPP Rel. 16 (3rd Generation Partnership Project Release 16), 3GPP Rel. 17 (3rd Generation Partnership Project Release 17), 3GPP Rel. 18 (3rd Generation Partnership Project Release 18), 3GPP 4G, 3GPP LTE Extra, LTE-Advanced Pro, LTE Licensed-Assisted Access (“LAA”), MuLTEfire, UMTS Terrestrial Radio Access (“UTRA”), Evolved UMTS Terrestrial Radio Access (“E-UTRA”), Long Term Evolution Advanced (4th Generation) (“LTE Advanced (4G)”), cdmaOne (“2G”), Code division multiple access 2000 (Third generation) (“CDMA2000 (3G)”), Evolution-Data Optimized or Evolution-Data Only (“EV-DO”), Advanced Mobile Phone System (1st Generation) (“AMPS (1G)”), Total Access Communication arrangement/Extended Total Access Communication arrangement (“TACS/ETACS”), Digital AMPS (2nd Generation) (“D-AMPS (2G)”), Push-to-talk (“PTT”), Mobile Telephone System (“MTS”), Improved Mobile Telephone System (“IMTS”), Advanced Mobile Telephone System (“AMTS”), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (“Autotel/PALM”), ARP (Finnish for Autoradiopuhelin, “car radio phone”), NMT (Nordic Mobile Telephony), High capacity version of NTT (Nippon Telegraph and Telephone) (“Hicap”), Cellular Digital Packet Data (“CDPD”), Mobitex, DataTAC, Integrated Digital Enhanced Network (“iDEN”), Personal Digital Cellular (“PDC”), Circuit Switched Data (“CSD”), Personal Handy-phone System (“PHS”), Wideband Integrated Digital Enhanced Network (“WiDEN”), iBurst, Unlicensed Mobile Access (“UMA”), also referred to as also referred to as 3GPP Generic Access Network, or GAN standard), Zigbee, Bluetooth®, Wireless Gigabit Alliance (“WiGig”) standard, mmWave standards in general (wireless systems operating at 10-300 GHz and above such as WiGig, IEEE 802.11ad, IEEE 802.11ay, etc.), technologies operating above 300 GHz and THz bands, (3GPP/LTE based or IEEE 802.11p and other) Vehicle-to-Vehicle (“V2V”) and Vehicle-to-X (“V2X”) and Vehicle-to-Infrastructure (“V2I”) and Infrastructure-to-Vehicle (“I2V”) communication technologies, 3GPP cellular V2X, DSRC (Dedicated Short Range Communications) communication arrangements such as Intelligent-Transport-Systems, and other existing, developing, or future radio communication technologies.

The apparatuses and methods described herein may use such radio communication technologies according to various spectrum management schemes, including, but not limited to, dedicated licensed spectrum, unlicensed spectrum, (licensed) shared spectrum (such as LSA=Licensed Shared Access in 2.3-2.4 GHz, 3.4-3.6 GHZ, 3.6-3.8 GHz and further frequencies and SAS=Spectrum Access System in 3.55-3.7 GHZ and further frequencies), and may use various spectrum bands including, but not limited to, IMT (International Mobile Telecommunications) spectrum (including 450-470 MHz, 690-960 MHz, 1710-2025 MHz, 2110-2200 MHz, 2300-2400 MHz, 2500-2690 MHz, 698-790 MHz, 610-790 MHz, 3400-3600 MHz, etc., where some bands may be limited to specific region(s) and/or countries), IMT-advanced spectrum, IMT-2020 spectrum (expected to include 3600-3800 MHz, 3.5 GHz bands, 600 MHz bands, bands within the 24.25-86 GHz range, etc.), spectrum made available under FCC's “Spectrum Frontier” 4G initiative (including 27.5-28.35 GHz, 29.1-29.25 GHz, 31-31.3 GHZ, 37-38.6 GHz, 38.6-40 GHz, 42-42.5 GHZ, 47-64 GHz, 64-71 GHz, 61-76 GHZ, 81-86 GHz and 92-94 GHz, etc.), the ITS (Intelligent Transport Systems) band of 4.9 GHZ (typically 4.85-5.925 GHz) and 63-64 GHz, bands currently allocated to WiGig such as WiGig Band 1 (57.24-59.40 GHZ), WiGig Band 2 (59.40-61.56 GHZ) and WiGig Band 3 (61.56-63.72 GHz) and WiGig Band 4 (63.72-65.88 GHz), the 60.2 GHz-71 GHz band, any band between 65.88 GHz and 61 GHz, bands currently allocated to automotive radar applications such as 66-81 GHZ, and future bands including 94-300 GHz and above. Furthermore, the apparatuses and methods described herein can also employ radio communication technologies on a secondary basis on bands such as the TV White Space bands (typically below 690 MHz) where e.g. the 400 MHz and 600 MHz bands are prospective candidates. Besides cellular applications, specific applications for vertical markets may be addressed such as PMSE (Program Making and Special Events), medical, health, surgery, automotive, low-latency, drones, etc. applications. Furthermore, the apparatuses and methods described herein may also use radio communication technologies with a hierarchical application, such as by introducing a hierarchical prioritization of usage for different types of users (e.g., low/medium/high priority, etc.), based on a prioritized access to the spectrum e.g., with highest priority to tier-1 users, followed by tier-2, then tier-3, etc. users, etc. The apparatuses and methods described herein can also use radio communication technologies with different Single Carrier or orthogonal frequency division multiplexing flavors (CP-orthogonal frequency division multiplexing, SC-FDMA, SC-orthogonal frequency division multiplexing, filter bank-based multicarrier (FBMC), OFDMA, etc.) and e.g. 3GPP NR (New Radio), which can include allocating the orthogonal frequency division multiplexing carrier data bit vectors to the corresponding symbol resources.

Radio communication technologies may be classified as one of a Short Range radio communication technology or Cellular Wide Area radio communication technology. Short Range radio communication technologies may include Bluetooth, WLAN (e.g., according to any IEEE 802.11 standard), and other similar radio communication technologies. Cellular Wide Area radio communication technologies may include Global System for Mobile Communications (“GSM”), Code Division Multiple Access 2000 (“CDMA2000”), Universal Mobile Telecommunications System (“UMTS”), Long Term Evolution (“LTE”), General Packet Radio Service (“GPRS”), Evolution-Data Optimized (“EV-DO”), Enhanced Data Rates for GSM Evolution (“EDGE”), High Speed Packet Access (HSPA; including High Speed Downlink Packet Access (“HSDPA”), High Speed Uplink Packet Access (“HSUPA”), HSDPA Plus (“HSDPA+”), and HSUPA Plus (“HSUPA+”)), Worldwide Interoperability for Microwave Access (“WiMax”) (e.g., according to an IEEE 802.16 radio communication standard, e.g., WiMax fixed or WiMax mobile), etc., and other similar radio communication technologies. Cellular Wide Area radio communication technologies also include “small cells” of such technologies, such as microcells, femtocells, and picocells. Cellular Wide Area radio communication technologies may be generally referred to herein as “cellular” communication technologies.

The term “terminal device” utilized herein refers to user-side devices (both portable and fixed) that can connect to a core network and/or external data networks via a radio access network. “Terminal device” can include any mobile or immobile wireless communication device, including user equipments (UEs), mobile stations (MSs), wireless stations (STAs), cellular phones, tablets, laptops, personal computers, wearables, multimedia playback and other handheld or body-mounted electronic devices, consumer/home/office/commercial appliances, vehicles, and any other electronic device capable of user-side wireless communications.

The term “network access node” as utilized herein refers to a network-side device that provides a radio access network with which terminal devices can connect and exchange information with a core network and/or external data networks through the network access node. “Network access nodes” can include any type of base station or access point, including macro base stations, micro base stations, NodeBs, evolved NodeBs (eNBs), gNodeBs, home base stations, remote radio heads (RRHs), relay points, Wi-Fi/WLAN access points (APs), Bluetooth master devices, terminal devices acting as network access nodes, and any other electronic device capable of network-side wireless communications, including both immobile and mobile devices (e.g., vehicular network access nodes, moving cells, and other movable network access nodes). As used herein, a “cell” in the context of telecommunications may be understood as a sector served by a network access node. Accordingly, a cell may be a set of geographically co-located antennas that correspond to a particular sectorization of a network access node. A network access node can thus serve one or more cells (or sectors), where the cells are characterized by distinct communication channels.

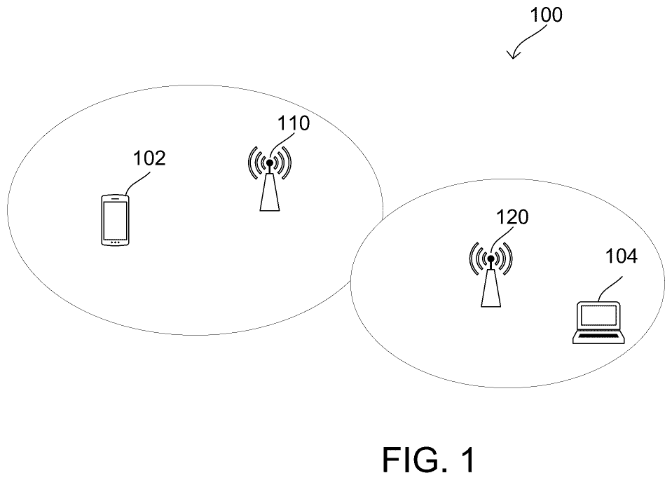

FIGS. 1 and 2 depict a general network and device architecture for wireless communications and/or sensing operations. FIG. 1 shows an exemplary radio communication network 100 according to some aspects, which may include terminal devices 102 and 104 and network access nodes 110 and 120 (e.g. radio access nodes). Radio communication network 100 may communicate with terminal devices 102 and 104 via network access nodes 110 and 120 over a radio access network. Each of terminal devices 102 and 104 or network access nodes 110 and 120 may be a sensing communication device as described herein that may perform a sensing operation. Although certain examples described herein may refer to a particular radio access network context (e.g., 6G, 5G NR, LTE, UMTS, GSM, other 3rd generation partnership project (3GPP) networks, WLAN/WiFi, Bluetooth, mmWave, etc.), these examples are demonstrative and may therefore be readily applied to any other type or configuration of radio access network. The number of network access nodes and terminal devices in radio communication network 100 is exemplary and is scalable to any amount.

In an exemplary cellular context, network access nodes 110 and 120 may be base stations (e.g., eNodeBs, NodeBs, Base Transceiver Stations (BTSs), gNodeBs, or any other type of base station), while terminal devices 102 and 104 may be cellular terminal devices (e.g., mobile stations (MSs), UEs, or any type of cellular terminal device). Network access nodes 110 and 120 may therefore interface (e.g., via backhaul interfaces) with a cellular core network such as an evolved packet core (EPC, for LTE), core network (CN, for UMTS), or other cellular core networks, which may also be considered part of radio communication network 100. The cellular core network may interface with one or more external data networks.

Network access nodes 110 and 120 (and, optionally, other network access nodes of radio communication network 100 not explicitly shown in FIG. 1) may accordingly provide a radio access network to terminal devices 102 and 104 (and, optionally, other terminal devices of radio communication network 100 not explicitly shown in FIG. 1). In an exemplary cellular context, the radio access network provided by network access nodes 110 and 120 may enable terminal devices 102 and 104 to wirelessly access the core network via radio communications. The core network may provide switching, routing, and transmission, for traffic data related to terminal devices 102 and 104, and may further provide access to various internal data networks (e.g., control nodes, routing nodes that transfer information between other terminal devices on radio communication network 100, etc.) and external data networks (e.g., data networks providing voice, text, multimedia (audio, video, image), and other Internet and application data). Furthermore, terminal devices 102 and 104 and network access nodes 110 and 120 may perform a sensing operation, particularly radar sensing, in accordance with joint communication and sensing (JCAS) architecture. In an exemplary short-range context, the radio access network provided by network access nodes 110 and 120 may provide access to internal data networks (e.g., for transferring data between terminal devices connected to radio communication network 100) and external data networks (e.g., data networks providing voice, text, multimedia (audio, video, image), and other Internet and application data).

In accordance with various aspects described herein, network access nodes 110 and 120 and terminal devices 102 and 104 perform their respective sensing operations in a manner, such that each device may perform its respective sensing operation according to its respective sensing signal configuration. Accordingly, each of these devices may generate and transmit its respective sensing signals according to a respective configuration that may include at least one of frequency resources used to transmit sensing signals, the bandwidth of the sensing signals, transmit power of the sensing signals, and waveform shape of the sensing signals which the respective device may determine before generating and/or transmitting the sensing signals. In some examples, a central orchestrator (e.g. a sensing orchestrator) may determine a respective sensing signal configuration for each device and send information representing the respective sensing signal configuration to the respective device.

The radio access network and core network (if applicable, such as for a cellular context) of radio communication network 100 may be governed by communication protocols that can vary depending on the specifics of radio communication network 100. Such communication protocols may define the scheduling, formatting, and routing of both user and control data traffic through radio communication network 100, which includes the transmission and reception of such data through both the radio access and core network domains of radio communication network 100. Accordingly, terminal devices 102 and 104 and network access nodes 110 and 120 may follow the defined communication protocols to transmit and receive data over the radio access network domain of radio communication network 100, while the core network may follow the defined communication protocols to route data within and outside of the core network. Exemplary communication protocols include 6G, 5G NR, LTE, UMTS, GSM, WiMAX, Bluetooth, WiFi, mmWave, etc., any of which may be applicable to radio communication network 100.

In various aspects, network access nodes 110 and 120 may include one or more central units (CUs), one or more distributed units (DU), and one or more radio units (RUs) to communicate with terminal devices 102 and 104. In various examples, a radio unit may include a device configured to implement various processing functions for communication. In particular, the RU may implement functions of a lower physical layer (PHY). A DU may include a device configured to implement various processing functions, in particular including functions of a higher physical layer (PHY), medium access control layer (MAC), and radio link control layer (RLC). The skilled person may realize that this is one example of a split of the network stack and DUs and RUs may have different split configurations. The RU may be linked to terminal devices 102 and 104 over a radio connection, and to the DU over a fronthaul interface. In various examples, the fronthaul interface may be according to a common public radio interface (CPRI) or an enhanced common public radio interface (eCPRI) configured to communicate over a connection via fiber optic cables, but there are also other communication mediums that may handle the fronthaul communication. In any event, the RUs may be serving a plurality of terminal devices, and there may be limitations in terms of link capacity and bandwidth with respect to the communication between the RUs and a corresponding DU over the fronthaul. It may be desirable to address some of the fronthaul limitations.

FIG. 2 shows an exemplary internal configuration of a communication device according to various aspects. Communication device 200 (i.e. a wireless communication device) may include various aspects of radio communication devices (e.g. network access nodes 110, 120) or various aspects of mobile radio communication devices (e.g. terminal device 102, 104) as well. Communication device 200 may include antenna system 202, RF transceiver 204, baseband modem 206 (including digital signal processor 208 and protocol controller 210), application processor 212, and memory 214. Although not explicitly shown in FIG. 2, in some aspects communication device 200 may include one or more additional hardware and/or software components, such as processors/microprocessors, controllers/microcontrollers, other specialty or generic hardware/processors/circuits, peripheral device(s), memory, power supply, external device interface(s), subscriber identity module(s) (SIMs), user input/output devices (display(s), keypad(s), touchscreen(s), speaker(s), external button(s), camera(s), microphone(s), etc.), or other related components.

Communication device 200 may transmit and receive radio signals on one or more radio access networks. Baseband modem 206 may direct such communication functionality of communication device 200 according to the communication protocols associated with each radio access network, and may execute control over antenna system 202 and RF transceiver 204 to transmit and receive radio signals according to the formatting and scheduling parameters defined by each communication protocol. Although various practical designs may include separate communication components for each supported radio communication technology (e.g., a separate antenna, RF transceiver, digital signal processor, and controller), for purposes of conciseness the configuration of communication device 200 shown in FIG. 2 depicts only a single instance of such components.

Communication device 200 may transmit and receive wireless signals with antenna system 202. Antenna system 202 may be a single antenna or may include one or more antenna arrays that each include multiple antenna elements. For example, antenna system 202 may include an antenna array at the top of communication device 200 and a second antenna array at the bottom of communication device 200. In some aspects, antenna system 202 may additionally include analog antenna combination and/or beamforming circuitry. In the receive (RX) path, RF transceiver 204 may receive analog radio frequency signals from antenna system 202 and perform analog and digital RF front-end processing on the analog radio frequency signals to produce digital baseband samples (e.g., in-phase/quadrature (IQ) samples) to provide to baseband modem 206. RF transceiver 204 may include analog and digital reception components including amplifiers (e.g., low noise amplifiers (LNAs)), filters, RF demodulators (e.g., RF IQ demodulators)), and analog-to-digital converters (ADCs), which RF transceiver 204 may utilize to convert the received radio frequency signals to digital baseband samples. In the transmit (TX) path, RF transceiver 204 may receive digital baseband samples from baseband modem 206 and perform analog and digital RF front-end processing on the digital baseband samples to produce analog radio frequency signals to provide to antenna system 202 for wireless transmission. RF transceiver 204 may thus include analog and digital transmission components including amplifiers (e.g., power amplifiers (PAs), filters, RF modulators (e.g., RF IQ modulators), and digital-to-analog converters (DACs), which RF transceiver 204 may utilize to mix the digital baseband samples received from baseband modem 206 and produce the analog radio frequency signals for wireless transmission by antenna system 202. In some aspects baseband modem 206 may control the radio transmission and reception of RF transceiver 204, including specifying the transmit and receive radio frequencies for operation of RF transceiver 204.

In accordance with various aspects provided herein, communication device 200 may perform sensing operations within the radio communication network 100. Illustratively, baseband modem 206, (e.g. the digital signal processor 208) may be configured to perform sensing-related signal processing in addition to traditional communication processing. For example, baseband modem 206 may be configured to implement techniques like radar waveform generation, matched filtering for target detection, parameter estimation (e.g., range, velocity, angle) of detected targets, and environmental mapping. In some examples, baseband modem 206 (e.g. the digital signal processor 208) may use its hardware accelerators and parallel processing capabilities to efficiently handle the computationally intensive sensing algorithms alongside communication tasks.

Furthermore, the baseband modem 206 (e.g. protocol controller 210) may be configured to coordinate and/or manage joint operation of communication and sensing functions. Illustratively, baseband modem 206 may schedule sensing and communication operations, allocate resources (e.g., time/frequency resources, antenna beams) between the sensing operations and the communication operations, and manage interference between them. Baseband modem 206 (e.g. the protocol controller 210) may further implement sensing control protocols and interfaces to enable coordination with other network entities for distributed sensing operations as described herein.

In some examples, the application processor 212 may be configured to act as a source and sink for sensing data, similar to its role for communication data. Application processor 212 may execute sensing applications that are configured to process and interpret the sensing data received from the baseband modem 206. Illustratively, application processor 212 may perform at least one of object detection and tracking, environmental mapping, and/or situational awareness services using the sensing data. In some examples, application processor 212 may interface with external sensors (e.g., cameras, lidars) to fuse data from multiple sensing modalities for enhanced perception capabilities.

Correspondingly, RF transceiver 204 may further support the transmission and reception of sensing waveforms in addition to communication signals. Illustratively, RF transceiver 204 may generate and transmit sensing signals (e.g., frequency-modulated continuous waveforms for radar), and may process the received sensing signals to extract target information. In some examples, RF transceiver 204 can use the same analog and digital components (e.g., amplifiers, filters, modulators/demodulators, ADCs/DACs) for sensing operations and the communication operations, potentially with additional hardware accelerators for sensing-specific tasks. Antenna system 202 may also support both communication and sensing functions, in some examples with separate antenna arrays or shared arrays with beamforming capabilities. In accordance with various aspects, antenna system 202 can form narrow beams for extended sensing range or wide beams for faster coverage, depending on the sensing requirements and resource constraints. Techniques like multiple input multiple output and beamforming can be employed to enhance the sensing performance and enable features like high-resolution target parameter estimation and interference mitigation.

As shown in FIG. 2, baseband modem 206 may include digital signal processor 208, which may perform physical layer (PHY, layer 1) transmission and reception processing to, in the transmit path, prepare outgoing transmit data provided by protocol controller 210 for transmission via RF transceiver 204, and, in the receive path, prepare incoming received data provided by RF transceiver 204 for processing by protocol controller 210. Digital signal processor 208 may be configured to perform one or more of error detection, forward error correction encoding/decoding, channel coding and interleaving, channel modulation/demodulation, physical channel mapping, radio measurement and search, frequency and time synchronization, antenna diversity processing, power control and weighting, rate matching/de-matching, retransmission processing, interference cancelation, and any other physical layer processing functions. Digital signal processor 208 may be structurally realized as hardware components (e.g., as one or more digitally-configured hardware circuits or field programmable gate array (FPGAs)), software-defined components (e.g., one or more processors configured to execute program code defining arithmetic, control, and I/O instructions (e.g., software and/or firmware) stored in a non-transitory computer-readable storage medium), or as a combination of hardware and software components. In some aspects, digital signal processor 208 may include one or more processors configured to retrieve and execute program code that defines control and processing logic for physical layer processing operations. In some aspects, digital signal processor 208 may execute processing functions with software via the execution of executable instructions. In some aspects, digital signal processor 208 may include one or more dedicated hardware circuits (e.g., application specific integrated circuits (ASICs), field programmable gate arrays, and other hardware) that are digitally configured to specific execute processing functions, where the one or more processors of digital signal processor 208 may offload certain processing tasks to these dedicated hardware circuits, which are known as hardware accelerators. Exemplary hardware accelerators can include fast fourier transform (FFT) circuits and encoder/decoder circuits. In some aspects, the processor and hardware accelerator components of digital signal processor 208 may be realized as a coupled integrated circuit.

Communication device 200 may be configured to operate according to one or more radio communication technologies. Digital signal processor 208 may be responsible for lower-layer processing functions (e.g., layer 1/PHY) of the radio communication technologies, while protocol controller 210 may be responsible for upper-layer protocol stack functions (e.g., data link layer/layer 2 and/or network layer/layer 3). Protocol controller 210 may thus be responsible for controlling the radio communication components of communication device 200 (antenna system 202, RF transceiver 204, and digital signal processor 208) in accordance with the communication protocols of each supported radio communication technology, and accordingly may represent the access stratum and non-access stratum (NAS) (also encompassing layer 2 and layer 3) of each supported radio communication technology. Protocol controller 210 may be structurally embodied as a protocol processor configured to execute protocol stack software (retrieved from a controller memory) and subsequently control the radio communication components of communication device 200 to transmit and receive communication signals in accordance with the corresponding protocol stack control logic defined in the protocol software. Protocol controller 210 may include one or more processors configured to retrieve and execute program code that defines the upper-layer protocol stack logic for one or more radio communication technologies, which can include data link layer/layer 2 and network layer/layer 3 functions. Protocol controller 210 may be configured to perform both user-plane and control-plane functions to facilitate the transfer of application layer data to and from radio communication device 200 according to the specific protocols of the supported radio communication technology. User-plane functions can include header compression and encapsulation, security, error checking and correction, channel multiplexing, scheduling and priority, while control-plane functions may include setup and maintenance of radio bearers. The program code retrieved and executed by protocol controller 210 may include executable instructions that define the logic of such functions.

Communication device 200 may also include application processor 212 and memory 214. Application processor 212 may be a central processing unit, and may be configured to handle the layers above the protocol stack, including the transport and application layers. Application processor 212 may be configured to execute various applications and/or programs of communication device 200 at an application layer of communication device 200, such as an operating system (OS), a user interface (UI) for supporting user interaction with communication device 200, and/or various user applications. The application processor may interface with baseband modem 206 and act as a source (in the transmit path) and a sink (in the receive path) for user data, such as voice data, audio/video/image data, messaging data, application data, basic internet/web access data, etc. In the transmit path, protocol controller 210 may therefore receive and process outgoing data provided by application processor 212 according to the layer-specific functions of the protocol stack, and provide the resulting data to digital signal processor 208. Digital signal processor 208 may then perform physical layer processing on the received data to produce digital baseband samples, which digital signal processor may provide to RF transceiver 204. RF transceiver 204 may then process the digital baseband samples to convert the digital baseband samples to analog RF signals, which RF transceiver 204 may wirelessly transmit via antenna system 202. In the receive path, RF transceiver 204 may receive analog RF signals from antenna system 202 and process the analog RF signals to obtain digital baseband samples. RF transceiver 204 may provide the digital baseband samples to digital signal processor 208, which may perform physical layer processing on the digital baseband samples. Digital signal processor 208 may then provide the resulting data to protocol controller 210, which may process the resulting data according to the layer-specific functions of the protocol stack and provide the resulting incoming data to application processor 212. Application processor 212 may then handle the incoming data at the application layer, which can include execution of one or more application programs with the data and/or presentation of the data to a user via a user interface.

Memory 214 may be a memory circuitry or a memory component of communication device 200, such as a hard drive or another such permanent memory device. Although not explicitly depicted in FIG. 2, the various other components of communication device 200 shown in FIG. 2 may additionally each include integrated permanent and non-permanent memory components, such as for storing software program code, buffering data, etc.

Communication device 200 may also include RFI generating devices 220 which may be the source of RFI which interferes with the operation of integrated wireless antenna 202. The operating points of RFI generating devices may generate RFI at an operating frequency range of radio modem components processing RF signals transmitted by or receive from antenna system 202 and then may be picked up by antenna system 202 through coupling 222. Communication device 200 may also include power management controller (PMC) 218. PMC 218 may interface and manage communication between devices of communication device 200.

In accordance with some radio communication networks, terminal devices 102 and 104 may execute mobility procedures to connect to, disconnect from, and switch between available network access nodes of the radio access network of radio communication network 100. As each network access node of radio communication network 100 may have a specific coverage area, terminal devices 102 and 104 may be configured to select and re-select \ available network access nodes in order to maintain a strong radio access connection with the radio access network of radio communication network 100. For example, terminal device 102 may establish a radio access connection with network access node 110 while terminal device 104 may establish a radio access connection with network access node 112. In the event that the current radio access connection degrades, terminal devices 102 or 104 may seek a new radio access connection with another network access node of radio communication network 100; for example, terminal device 104 may move from the coverage area of network access node 112 into the coverage area of network access node 110. As a result, the radio access connection with network access node 112 may degrade, which terminal device 104 may detect via radio measurements such as signal strength or signal quality measurements of network access node 112. Depending on the mobility procedures defined in the appropriate network protocols for radio communication network 100, terminal device 104 may seek a new radio access connection (which may be, for example, triggered at terminal device 104 or by the radio access network), such as by performing radio measurements on neighboring network access nodes to determine whether any neighboring network access nodes can provide a suitable radio access connection. As terminal device 104 may have moved into the coverage area of network access node 110, terminal device 104 may identify network access node 110 (which may be selected by terminal device 104 or selected by the radio access network) and transfer to a new radio access connection with network access node 110. Such mobility procedures, including radio measurements, cell selection/reselection, and handover are established in the various network protocols and may be employed by terminal devices and the radio access network in order to maintain strong radio access connections between each terminal device and the radio access network across any number of different radio access network scenarios.

Aspects described herein may include apparatus and methods to avoid RFI in a wireless communication device. Dynamically avoiding RFI may enable wireless communication devices to avoid RFI from RFI generating devices at a point in time and for as long as required for wireless operation. Dynamically avoiding RFI in real time can minimize the potential impact on performance and functionality of wireless communications and may only invoke mitigation techniques when required for operation. Compared to other physical design constraints or static RFI avoidance, dynamic RFI avoidance can minimize the impact on the power and performance of the wireless communication device. Dynamic RFI avoidance can provide a cost-effective method with little or no impact to the printed circuit board (PCB) form factor or mechanical and thermal complexities. Additionally, the highly dynamic RFI avoidance may use device to device communication which may be completed in microseconds and create a seamless user experience.

Many wireless communication systems may implement physical design constraints to avoid RFI. For example, the wireless communication system may include shielding, antenna keep out zones, and/or PCB layout and routing rules to avoid RFI. Physical design constraints to avoid RFI may have multiple limitations. For example, shielding and complex PCB layout and routing rules increase the Z-height and PCB area leading to increased cost. Type-4 PCBs are necessary to break out the pinout of system-on-chip (SOC) s and meet shield grounding requirements which again add to cost. Shield grounding requires many closely spaced vertical interconnect access (vias), connecting the periphery of the shield to the PCB ground plane because shielding is not very effective unless it is well grounded. The need to keep shielding continuous may cause thermal performance issues because it may lack gaps or holes for ventilation. Current shielding solutions may not be effective enough for ultra-high frequencies such as 5 GHz˜7 GHz or mmWave Wi-Fi/Cellular frequency bands.

Static RFI avoidance is typically not feasible nor practical in a functioning system. For example, permanently setting all of the devices' operating frequencies and conditions such that RFI always falls outside of the radio operating frequencies to eliminate any RFI in the wireless communication device. In an example, setting fixed DDR speeds or avoiding highest frequency points can result in non-optimal dynamic random-access memory (DRAM) settings, impacting power and performance. Some operating frequencies may also be dictated by external industry specifications. In other cases, the desired wireless operational channel can be dictated by the network (e.g. channels used by access points or cellular base stations).

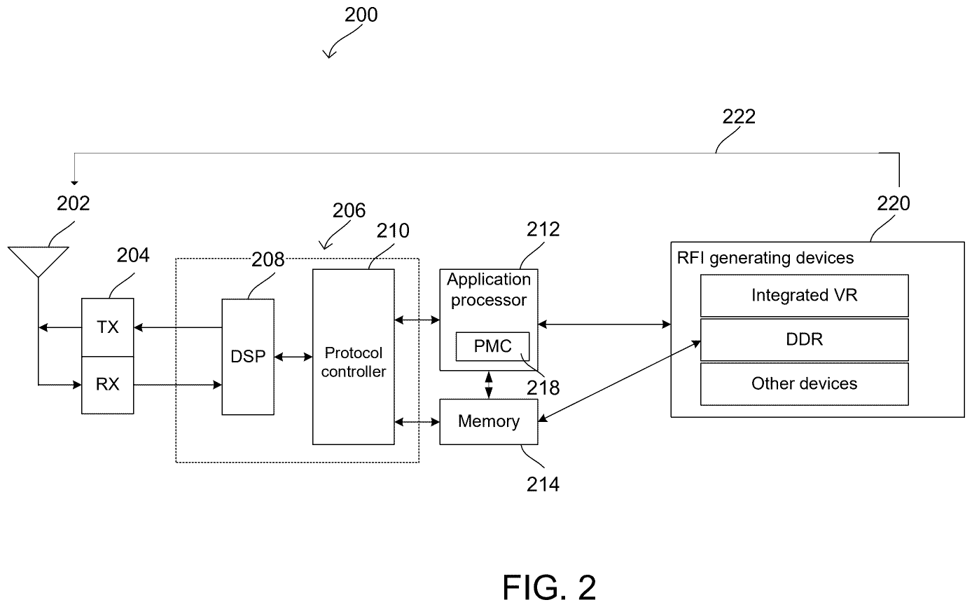

FIG. 3 shows an illustrative example of an apparatus in accordance with various aspects described herein. A communication device (e.g. communication device 200) may include the apparatus 300. Illustratively, the communication device may be a network access node 110, 120, or a terminal device 102, 104.

The apparatus 300 may include a processor 301, a memory 302, and a communication interface 303 configured to receive and transmit communication signals in order to communicate with further communication devices. In some aspects, the communication interface 303 may include one or more signal paths to carry communication signals. The communication interface 303 may include one or more transceivers. In some examples, the communication interface 303 may include one or more antenna ports to couple one or more antennas of the communication device.

The processor 301 may include one or more processors, which may include a baseband processor and an application processor (e.g. application processor 212, baseband modem 206). In various examples, the processor 301 may include a central processing unit, a graphics processing unit, a hardware acceleration unit (e.g. one or more dedicated hardware accelerator circuits (e.g., application specific integrated circuits, field programmable gate arrays, and other hardware)), a neuromorphic chip, and/or a controller. The processor 301 may be implemented in one processing unit, e.g. a system on chip (SOC), or a processor. In accordance with various examples, the processor 301 may further provide further functions to process received communication signals. The memory 302 may store various types of information required for the processor 301, or the communication interface 303 to operate in accordance with various aspects described herein.

The communication interface 303 may include one or more components allowing the apparatus to communicate with further communication devices. The communication interface 303 may include a transceiver (e.g. RF transceiver 204) configured to transmit and receive radio communication signals within a designated frequency band. Illustratively, a communication signal may have a designated channel bandwidth within the designated frequency band. The communication interface 303 may communicate with the further communication devices over established connections (i.e. links). In some examples, the processor 301 may implement corresponding software (e.g. drivers) interfacing with the communication interface 303 to control respective software and hardware components of the communication interface 303.

A wireless communication link may refer to a connection established between the communication device including the apparatus and a further communication device for the purpose of transmitting and/or receiving communication signals. The wireless communication link may operate based on a designated communication protocol and may be established within a radio frequency channel or band. The wireless communication link may support various types of communication, including unidirectional or bidirectional data transfer. The communication interface 303, which may include components such as transceivers and antennas, may be configured to facilitate the establishment and maintenance of the wireless communication link. Examples of wireless communication links may include connections based on technologies such as Wi-Fi, Bluetooth, or cellular protocols (e.g., LTE, 5G). The properties of the wireless communication link, such as bandwidth, latency, and throughput, may vary depending on the configuration and environment in which the communication device operates.

A radio frequency channel may refer to a portion of the radio frequency spectrum allocated for communication between the communication device and the further communication device. The radio frequency channel may be characterized by a center frequency and a specified bandwidth, which may collectively determine the range of frequencies used for transmitting and receiving communication signals. The radio frequency channel may provide the medium through which wireless communication signals are transmitted or received by the communication interface 303. In some examples, radio frequency channels may be designated within broader frequency bands and may adhere to regulatory requirements for frequency allocation. The processor 301 and communication interface 303 may perform operations to ensure that communication signals are transmitted within the designated radio frequency channel.

In some examples, the communication interface 303 may include a wired communication interface to communicate with further communication devices via physical wired connections. This wired connection may include one or more various physical interfaces. The processor 301 and the communication interface 303 may be configured to facilitate the physical interface and communicate through the physical interface with those further communication devices.

In accordance with various aspects described herein, the processor 301 may determine a utilization state of a wireless communication link established through a communication interface 303, which may operate within a designated radio frequency channel. Based on the utilization state, the processor 301 may instruct the RFI generating device to adjust its operating frequency, ensuring minimal interference with the active communication link. In various examples provided herein, the instruction of RFI generating device to adjust its operating frequency may include instructing the RFI generating device to vacate its operating frequency.

A utilization state may refer to a state (e.g. a condition, a configuration) or metric that represents the extent to which a wireless communication link is being actively used. The utilization state may include various information representing activity or inactivity on the wireless communication link. Examples of utilization states may include, but are not limited to, metrics such as the volume of data traffic being transmitted or received over the link, volume of data traffic that have been transmitted or received over the link within a designated period of time, the signal strength or quality associated with the link, whether the link is in an active mode (e.g., actively transmitting or receiving data) or an inactive mode (e.g., idle or disconnected), or an amount of time or a number in which the link has been in an active mode or an inactive mode within a designated period of time. The processor 301 may determine the utilization state by analyzing data provided by the communication interface 303 or other components of the wireless communication device, and/or monitoring its operations with the communication interface 303. For example, the processor 301 may monitor events or parameters such as network traffic patterns, signal quality indicators, or the presence of ongoing communication sessions to determine the utilization state.

In an example, a utilization state of a wireless communication link may represent an active state. The active state may be the case in which the utilization (e.g. usage) of the wireless communication link is to be above a certain activity threshold. The utilization state of a wireless communication link may also represent an inactive state. The inactive state may be the case in which the utilization (e.g. usage) of the wireless communication link is to be below a certain inactivity threshold. In some examples, the activity threshold and the inactivity threshold may be identical thresholds. Illustratively, the processor 301 may determine the state based on comparisons of events, signals, or measurements, etc. associated with the wireless communication link and the respective threshold(s).

The utilization state may represent the level of activity on the link, encompassing parameters such as data throughput, connection status, or signal quality. The communication interface 303 may facilitate this determination by monitoring traffic metrics and signaling events indicative of the usage of the wireless communication link and generating corresponding data for the processor 301 to make the determination. For instance, in a dual-radio setup, the communication interface 303 may assess metrics like bandwidth consumption for both Wi-Fi and cellular links. The processor 301 may use software modules to analyze utilization metrics provided by the communication interface 303. For example, the processor 301 may process packet counters or measure received signal strength indicators (RSSI) to ascertain the activity of the wireless communication link. In an example, the memory 302 may store historical data and thresholds for utilization states to enable comparative analysis. In some examples, the processor 301 may employ machine learning algorithms to predict future utilization states based on historical data patterns. This predictive approach may enable preemptive frequency adjustments, enhancing performance in scenarios like high-demand streaming or concurrent multi-link operations.

The wireless communication link may provide unidirectional or bidirectional communication, supporting a variety of communication protocols such as Wi-Fi, cellular, or Bluetooth offering a wide range of radio frequency channels to be used for wireless communication links. The RFI generating device may operate at different frequencies, where higher frequencies may offer improved performance but also potentially cause interference in case the communication interface 303 receives or transmits radio communication signals via the wireless communication link in an RF channel that overlaps with those higher frequencies. The processor 301 may dynamically adapt these frequencies to align with the operational requirements of the wireless communication link.

In an example, the processor 301 may determine the operating frequency of an RFI generating device that may affect the wireless communication link with its operation at the operating frequency. The operating frequency may influence the interference characteristics of the RFI generating device and also operation efficiency and/or performance. In some examples, the RFI generating device, integrated within or external to the apparatus 300, may provide its operating frequency data to the processor 301, which may be referred to as operating frequency information. In an example, the operating frequency information may be predefined, for example according to attributes of the RFI generating device and/or the wireless communication. The operating frequency information may be stored within the memory 302 (e.g. in a lookup table) or dynamically monitored through internal diagnostics. In an example, the processor 301 may retrieve the operating frequency information from the RFI generating device via designated communication protocols supported by the wireless communication device. The memory 302 may maintain information correlating operating frequencies with potential interference patterns across different radio frequency channels. The RFI generating device may include adaptive frequency control mechanisms that adjust frequencies based on feedback from the processor 301. This feedback loop may utilize real-time interference measurements to refine frequency selection dynamically.

In an example of the RFI generating device being a memory device (e.g. DDR memory), the operating frequency information may include information representing a table below:

DDRF Table

| Rate (MT/s) | Radio Frequency Channels |
|---|---|
| 2600 | 5 GHz [34, 36, 38, 40, 42, 50] |
| 5200 | 5 GHz [34, 36, 38, 40, 42, 50] |
| 6000 | 6 GHz [3, 5, 7, 9, 11, 15, 31] |
| 6400 | 6 GHz [63, 79, 83, 85, 87, 89, 91, 95] |

A DDR memory may include dynamic random-access memory (DRAM), which is a type of volatile memory. DRAM may operate by storing each bit of data in a separate capacitor within an integrated circuit, requiring periodic refresh cycles to maintain the stored data. Examples of DRAM devices include DDR memory, commonly used in desktops and servers for general-purpose computing; low power DDR (LPDDR), designed for mobile and embedded systems where energy efficiency is critical; and graphics DDR (GDDR), optimized for high-performance graphical and parallel computing tasks in GPUs and gaming consoles. Additional examples may include DDR5 and HBM (high bandwidth memory), a specialized DRAM type for high-performance tasks like AI, and advanced graphics applications. A memory device described herein may include a DRAM as a memory unit and further components for operation of the memory device (i.e. of the memory unit), for example, designated intellectual property blocks, such a controller, to facilitate and manage data exchanges between the processor 301 and the memory unit.

In the above representation of the operating frequency information, rate information corresponds to the operating frequency of the RFI generating device, which may be the data rate of the memory in the memory device example. Radio frequency channel information corresponds to channels of a wireless communication technology, which are illustrated as Wi-Fi channels in respective frequency bands. The mapping of the table may indicate possible unwanted configurations in terms of RFI. For example, if the data rate of the memory device is 6400 MT/, corresponding operating frequency may interfere with corresponding radio frequency channels, such as RF channel 63 within 6 GHz band operation of Wi-Fi. In this mapping, rate information may be referred to as “undesired operating frequency” with respect to corresponding radio frequency channels in the table. Similarly, radio frequency channel information may be referred to as “undesired radio frequency channel” with respect to corresponding operating frequency of the RFI generating device. Illustratively, an operating frequency in this table overlaps with radio frequency channels corresponding to the operating frequency in the table.

It is to be noted that the operating frequency information may include any type of information that represents configurations of operation frequency and radio frequency channels of a wireless communication link, from which configurations that may cause undesired interference as described herein. Illustratively, instead of the table above, the operating frequency information may include operating frequencies of the RFI generating device, and for each operating frequency, radio frequency channels that are predefined for less-interfering configurations.

The operating frequency information may further include information representing current operating frequency of the RFI generating device during its operation. In some examples, the processor 301 may be configured to adjust the operating frequency of the RFI generating device from a first operating frequency to a second operating frequency, if an established wireless communication link is configured for an operation within a radio frequency channel corresponding to the first operating frequency (e.g.

In an example, the processor 301 may instruct the RFI generating device to adjust its operating frequency based on the utilization state of the wireless communication link. This adjustment may aim to minimize interference while maintaining the performance of both the RFI generating device and the communication link. The processor 301 may send control signals, which may also be referred to messages herein, to the RFI generating device through interfaces within the apparatus 300. The control signals may specify target frequencies or provide guidelines for adaptive frequency modulation. For example, according the illustrative example of the DDRF table above, when the wireless communication link is at RF channel 63, the processor may send the control signal indicating the rate of 5200 MT/s based on the utilization state of the wireless communication link (e.g. if the link is and/or has become active). The adjustment process may involve algorithms that compare the utilization state of the wireless communication link with predefined thresholds stored in the memory 302. If the utilization state indicates high activity, the processor 301 may prioritize frequency adjustments to protect the wireless communication link's performance. In scenarios involving multi-link operations, the processor 301 may implement priority-based adjustments, favoring links with higher utilization states. For example, in a dual-band Wi-Fi configuration, the processor 301 may optimize frequencies to support the channel carrying the majority of the data traffic.

The processor 301 may manage utilization states and operating frequencies in wireless communication devices equipped with dual-radio systems. For instance, if both Wi-Fi and cellular links are active, the processor 301 may evaluate utilization metrics for each link and prioritize frequency adjustments accordingly. The communication interface 303 may support monitoring of both links within the same time period, ensuring comprehensive interference management. For wireless communication devices leveraging multi-link operation features, the processor 301 may analyze utilization states across multiple channels. If a Wi-Fi channel affected by RFI carries minimal traffic, the processor 301 may avoid or prevent unnecessary frequency adjustments to preserve RFI generating device performance and computational efficiency. In scenarios where the wireless communication device include Ethernet connection, the processor 301 may deactivate RFI mitigation for the wireless link if the Ethernet connection is active. The communication interface 303 may facilitate this transition by signaling the processor 301 about the change in network usage. The processor 301 may subsequently configure the operating frequency of the RFI generating device for scenarios involving wired connectivity.

The memory 302 may store training datasets for machine learning models, enabling the processor 301 to predict interference patterns and utilization trends. These models may enhance the device's ability to manage frequencies adaptively, supporting scenarios such as high-density environments or fluctuating network loads. The processor 301 may utilize adaptive policies stored in the memory 302 to refine frequency adjustments dynamically. Lookup tables correlating utilization states, operating frequencies, and interference patterns may enable rapid decision-making.

The processor 301 may identify high utilization of the Ethernet connection while the Wi-Fi link remains idle. The processor 301 may deactivate RFI mitigation for the wireless communication link, allowing the RFI generating device to operate at an optimal frequency for memory performance. In a mobile device supporting both Wi-Fi and 5G cellular networks, the processor 301 may determine that the cellular link has a higher utilization state. The processor 301 may prioritize frequency adjustments to protect the cellular link, leveraging real-time metrics provided by the communication interface 303. For a device using two Wi-Fi bands, the processor 301 may detect that one band carries the majority of the traffic. The processor 301 may instruct the RFI generating device to adjust frequencies to protect the high-traffic band while deprioritizing the secondary band.

The wireless communication device may dynamically manage RFI through coordination of the processor 301. In an example, the processor 301 may determine or adjust the operating frequency of the RFI generating device based on operating frequency information stored in the memory 302. In some examples, the operating frequency information may include predefined frequency ranges or historical data on interference patterns. For instance, the memory 302 may maintain a table, as illustratively described above, mapping operating frequencies of the RFI generating device to specific radio frequency channels to ensure that any interference is minimized. The processor 301 may access this stored information when determining the operating frequency of the RFI generating device to operate, by correlating this data with the current utilization state of the wireless communication link.

For example, the processor 301 may analyze data received from the communication interface 303 (e.g. real-time data), which may indicate the utilization state of the wireless communication link, and compare the data with the stored frequency information. For example, the processor 301 may first identify the frequency range of the radio frequency channel currently in use by the RFI generating device and compare the frequency range against stored data to identify a configuration with undesired interference. Based on this analysis, the processor 301 may instruct the RFI generating device to adjust its frequency to avoid interference while maintaining optimal system performance.

In an example, the processor 301 may instruct the RFI generating device to adjust its operating frequency if the operating frequency overlaps with the radio frequency channel to ensure that any potential interference caused by the RFI generating device does not degrade the performance of the wireless communication link. In particular, the processor 301 may instruct the adjustment if the utilization state of the wireless communication link is representative of an active state. The processor 301 may instruct to adjust the operating frequency to a frequency that does not overlap with the radio frequency channel.

Furthermore, the processor 301 may prevent instructing the adjustment if the utilization state is representative of an inactive state, even if the operating frequency overlaps with the radio frequency channel. The processor 301 may send an override signal to a controller instructing the adjustment in this case. In some examples, if the current operating frequency of the RFI generating device is adjustable to a further operating frequency (e.g. in which the RFI generating device has a more efficient/performative configuration) and if the further operating frequency overlaps with the radio frequency channel, the processor 301 may instruct the RFI generating device to operate with the further operating frequency if the utilization state is representative of an inactive state.

The processor 301 may determine the overlap by analyzing the frequency range of the radio frequency channel as reported by the communication interface 303. For instance, the communication interface 303 may continuously monitor the active channel's boundaries and provide this data to the processor 301, which then compares it to the operating frequency of the RFI generating device. Alternatively, or additionally, the processor 301 may configure the establishment of the wireless communication link including a determination of the radio frequency channel of the link. In an example, the memory 302 may store radio frequency channel of established wireless communication links.

For example, if the RFI generating device operates at a frequency overlapping with the center or edges of the active radio frequency channel, the processor 301 may instruct the RFI generating device to shift its frequency to a non-overlapping range, if the utilization state represents an active state. If the RFI generating device operates at a frequency overlapping with the center or edges of the active radio frequency channel, the processor 301 may instruct the RFI generating device to continue operating with its operating frequency in an overlapping range, if the utilization state represents an inactive state.

In another example, the processor 301 may instruct the RFI generating device to adjust its operating frequency if it falls within the radio frequency channel or within a first predetermined proximity to the channel. This proximity-based management may ensure that interference from the RFI generating device is mitigated effectively with a predetermined degree corresponding to the predetermined proximity, particularly in scenarios where precise frequency alignment is critical. The processor 301 may apply similar operations based on the utilization state as described in the overlapping configuration.

The processor 301 may instruct the RFI generating device to operate at a particular frequency if the utilization state of the wireless communication link is representative of an inactive state. To facilitate this feature, the processor 301 may first analyze the utilization state of the wireless communication link. If the communication link is inactive—such as during periods of idle connection or when network traffic is routed through a wired interface—the processor 301 may optimize the operating frequency of the RFI generating device for other performance metrics, such as power efficiency or memory operations. The memory 302 may store thresholds or configurations defining inactive states, enabling the processor 301 to make informed decisions. In particular, the processor 301 may instruct the RFI generating device at the operating frequency even if there is an overlap with the radio frequency channel of the wireless communication link, when the utilization state is representative of an inactive state.

For example, the processor 301 may determine that the link is inactive if the data traffic remains below a predefined threshold for a specified duration. Once the inactive state is confirmed, the processor 301 may adjust the operating frequency of the RFI generating device to align with non-critical operational needs. This adjustment may include shifting to a frequency range that prioritizes the device's memory performance or other subsystems, even if there is an overlap with the radio frequency channel of the wireless communication link.

For example, the communication interface 303 may switch from a wireless connection to a wired Ethernet connection for data communication. In such cases, the processor 301 may detect the inactivity of the wireless communication link and adjust the operating frequency of the RFI generating device accordingly. Another example may involve offline activities, such as local gaming or video playback, where the wireless link remains idle. The processor 301 may optimize the operating frequency of the RFI generating device to enhance overall system performance during such activities.

In another example, the processor 301 may instruct the RFI generating device to adjust its operating frequency if it falls within the radio frequency channel or within a first predetermined proximity to the channel, especially if the utilization state of the wireless communication link is representative of an active state. In an example, the processor 301 may instruct the RFI generating device to operate at a frequency outside a second predetermined proximity to a frequency within the radio frequency channel, especially if the utilization state is representative of an active state. This broader proximity management ensures that the RFI generating device operates in ranges unlikely to interfere with the wireless communication link. The communication interface 303 may provide the processor 301 with continuous updates on active frequency usage, enabling real-time adjustments. Implementation of this feature may involve adaptive algorithms that consider network conditions and historical interference patterns. For instance, in multi-radio configurations, the processor 301 may prioritize frequencies furthest from high-utilization channels to enhance system performance.

In an example, the utilization state of the wireless communication link may include a metric representative of data traffic, such as the volume of transmitted or received data over a given period. The processor 301 may determine this utilization state by analyzing traffic patterns reported by the communication interface 303 and/or by analyzing scheduled and/or performed transmissions and receptions, for example at MAC layer. This analysis may involve monitoring packet counters, throughput metrics, and signal quality indicators. Based on these metrics, the processor 301 may determine whether interference mitigation (i.e. keeping the operating frequency of the RFI generating device and radio frequency channel of wireless communication link in a non-overlapping configuration) is necessary. For example, if the utilization state indicates low traffic, the processor 301 may deprioritize frequency adjustments, thereby conserving system resources. For this purpose, the processor 301 may calculate and interpret utilization metrics based on monitoring of communication activities via the wireless communication link. The memory 302 may store thresholds that guide these calculations. The processor 301 may use these thresholds to prioritize frequency adjustments during high-utilization periods while minimizing unnecessary changes during low-traffic conditions

In an example, the processor 301 may adjust the operating frequency of the RFI generating device if the metric representative of data traffic exceeds a predefined threshold (e.g. indicates an active state). Conversely, if the traffic metric is below the threshold (e.g. indicates an inactive state), the operating frequency may be maintained. This may ensure that interference mitigation actions are aligned with the operational needs of the communication link. The processor 301 may compare real-time traffic data against thresholds stored in the memory 302, prioritizing adjustments only when necessary. For instance, in a dual-radio setup, the processor 301 may adjust frequencies to protect the more critical link if its traffic exceeds the threshold.

In some aspects, the processor 301 may also implement dynamic thresholding, where thresholds are adjusted based on historical data or real-time conditions. This may enable the wireless communication device to adapt to fluctuating traffic patterns, to ensure optimal performance under diverse scenarios. For example, in a high-density environment with multiple active links, the processor 301 may prioritize interference mitigation for the link carrying the highest traffic load.

In an example, the processor 301 may determine the utilization state of a wireless communication link by monitoring events representing the usage of a network connected via the wireless communication link. Such events may include at least one or a combination of the initiation or termination of data transmission sessions, the volume of packets transmitted or received, changes in signal strength or quality, and the presence of retransmissions due to errors or congestion, and the like. In some examples, the processor 301 may analyze these events to determine the link as active or inactive.

The communication interface 303 may provide information representing those metrics regarding these events, such as timestamps for packets or counts of transmitted and acknowledged frames. In some examples, the processor 301 may implement corresponding layer of the communication protocol stack (e.g. MAC layer, PHY layer) governing the wireless communication link. The memory 302 may store predefined thresholds or rules that correlate specific event patterns with different utilization states. For example, a high volume of transmitted packets may indicate an active utilization state, while prolonged inactivity in packet exchanges may represent an idle state. Illustratively, the processor 301 may be configured to continuously process event data captured by the communication interface 303 based on statistical models for identifying trends in network activity. This may enable the processor 301 to adjust the operating frequency of the RFI generating device based on real-time link utilization states.

In an example, the processor 301 may determine a first utilization state for a first wireless communication link and a second utilization state for a second communication link, in case of a presence of multiple communication links between the wireless communication device and one or more further communication devices. The second communication link may be at least one or more second communication links, which may include a further wireless communication link and a wired communication link (e.g. Ethernet). The further wireless communication link may be a wireless communication of the same technology (e.g. both Wi-Fi) or a wireless communication of another communication technology (e.g. one Wi-Fi, one cellular).

The processor 301 may analyze data from the communication interface 303 for each established link and compare this data with operating frequency information stored in the memory 302. This information may include predefined frequency mappings, interference patterns, or thresholds corresponding to different utilization states. Based on these states, the processor 301 may instruct the RFI generating device to adjust its operating frequency to optimize performance across both links or instruct to use its operating frequency.

To compliment the presence of multiple communication links and multiple utilization states, the operating frequency information may include information representing mapping configurations correlating the operating frequencies of the RFI generating device with the radio frequency channels of all detected communication links, at least all present wireless communication links. For instance, the operating frequency information may include distinct policies for each wireless communication link, especially for each wireless communication technology, illustratively for Wi-Fi and cellular links, defining separate interference mitigation strategies based on their respective communication protocols and frequency characteristics. The processor 301 may prioritize interference mitigation based on the utilization state of each link. For example, if a Wi-Fi link operates in a high-traffic state while a cellular link is idle, the processor 301 may adjust the RFI generating device's frequency to minimize interference with the Wi-Fi link.

The communication interface 303 may monitor the activity of each communication link, providing metrics such as bandwidth utilization, latency, and retransmission rates. The memory 302 may store separate utilization thresholds for each link, allowing the processor 301 to evaluate and prioritize them based on real-time conditions. For instance, if the first link supports a critical application with high traffic, while the second link is idle, the processor 301 may prioritize interference mitigation for the first link. Correspondingly, the processor 301 may obtain data about multiple links to determine respective utilization states as described herein for a wireless communication link, and dynamically manage the operating frequency of the RFI generating device.

Illustratively, the communication interface 303 may continuously monitor established wireless communication links, their active channels, signal strength, and traffic metrics for each link. The processor 301 may obtain data based on this monitoring to dynamically evaluate overlap conditions between the operating frequency of the RFI generating device and the frequency channels of each communication link. If overlap conditions exist, the processor 301 may determine whether the utilization state of a specific link justifies a frequency adjustment. For example, if both Wi-Fi and cellular links are active but the cellular link carries significantly higher traffic, the processor 301 may prioritize interference mitigation for the cellular link.

In illustrative multi-link Wi-Fi configurations, such as those supporting Wi-Fi 7 multi-link operation, the processor 301 may monitor the utilization states of each Wi-Fi link and dynamically balance interference mitigation strategies. For example, if one Wi-Fi link operates in the 2.4 GHz band and another in the 5 GHz band, the processor 301 may prioritize interference mitigation for the link experiencing higher traffic. If both links are affected by interference, the processor 301 may initiate a coordinated adjustment strategy to minimize the impact across all links, illustratively by adjusting the operating frequency of the RFI generating device to a frequency that does not overlap with both radio frequency channels within respective 2.4 GHz and 5 GHz bands.

Illustratively, the processor 301 may integrate data from network drivers for Wi-Fi, cellular, and Ethernet connections to assess overall network utilization. For instance, if the Wi-Fi driver reports low traffic while the Ethernet driver indicates high traffic, the processor 301 may optimize the operating frequency of the RFI generating device for the Ethernet link. In an example, when both Wi-Fi and cellular links are active, the processor 301 may detect the presence of double RFIs affecting both links. Instead of deactivating the interference mitigation, the processor 301 may assess the traffic patterns and prioritize mitigation for the link carrying the critical data load. For instance, if the cellular link supports a video call while the Wi-Fi link handles low-priority background traffic, the processor 301 may adjust the operating frequency of the RFI generating device to ensure uninterrupted video quality.

The processor 301 may also address scenarios involving inactive links. If one or more communication links are inactive, such as during idle periods or when traffic is routed through a wired Ethernet connection, the processor 301 may optimize the operating frequency of the RFI generating device for parameters like power efficiency or computational performance. For example, the processor 301 may allow the RFI generating device to operate within overlapping frequency ranges of inactive links, conserving resources while minimizing interference.

In some examples, the processor 301 may dynamically switch between communication links based on their utilization states and frequency characteristics. For example, if a Wi-Fi link encounters heavy interference while a cellular link remains unaffected, the processor 301 may prioritize data transmission over the cellular link. This capability ensures that the wireless communication device maintains optimal connectivity even in challenging environments. To ensure seamless operation, the processor 301 may preconfigure thresholds, policies, and algorithms for interference mitigation based on the specific requirements of each communication link. For instance, the memory 302 may store configurations defining active and inactive states for Wi-Fi and cellular links, allowing the processor 301 to make informed decisions in real time.

In an example, the first communication link may operate based on IEEE 802.11 Wi-Fi standards, and the second communication link may utilize cellular protocols such as LTE or 5G. The processor 301 may determine the utilization state for each link and adjust the operating frequency of the RFI generating device to prioritize the link requiring higher bandwidth or reliability. Illustratively, the communication interface 303 may provide separate data streams for Wi-Fi and cellular connections, including signal quality metrics and traffic statistics. The processor 301 may compare these metrics against thresholds stored in the memory 302 to determine a respective utilization state for each link. For instance, the processor 301 may detect that the cellular link is carrying a video call, while the Wi-Fi link is idle. In this case, the processor 301 may adjust the RFI generating device to minimize interference with the cellular link, in which the processor 301 may adjust the operating frequency of the RFI generating device in a manner that it overlaps with the radio frequency channel of the Wi-Fi link.

In an example, both the first and second communication links may operate under IEEE 802.11 standards as part of a multi-link operation. The processor 301 may determine the utilization state of each Wi-Fi link and adjust the operating frequency of the RFI generating device to optimize performance across the multi-link operation configuration. The communication interface 303 may monitor metrics for each link, such as channel congestion, throughput, and latency. The processor 301 may analyze these metrics to identify which link carries the majority of traffic or is more sensitive to interference. For instance, if one link is supporting a high-definition video stream while the other is idle, the processor 301 may prioritize interference mitigation for the active link.

In an example, the processor 301 may select the first or second communication link for data communication based on their respective radio frequency channels and the operating frequency of the RFI generating device. This selection ensures optimal utilization of communication resources while avoiding unnecessary interference. The processor 301 may obtain the frequency ranges of the active channels for each link, along with real-time metrics such as traffic load or channel availability. The processor 301 may use this information to identify the link that is least impacted by interference from the RFI generating device. For example, if the first link operates in a congested 2.4 GHz band while the second link uses a relatively free 5 GHz band, the processor 301 may prioritize the second link.

In an example, the processor 301 may determine the operating frequency of the RFI generating device based on the frequency channels of both the first and second communication links during dual-radio concurrent operation to ensure efficient RFI management when both links are active simultaneously. The processor 301 may, based on data provided by the communication interface 303, monitor the frequency ranges and utilization states of both links. The memory 302 may store channel interference patterns or historical data to assist the processor 301 in making informed decisions. For instance, if the first link operates close to the RFI generating device's current operating frequency, while the second link is farther away, the processor 301 may prioritize protecting the first link.

In an example, the processor 301 may determine a result representative of whether to prioritize the operation of the RFI generating device or the wireless communication link based on the utilization state. For instance, the utilization state may indicate the traffic demand or signal quality of the wireless communication link, which can help the processor 301 decide whether interference mitigation is necessary. Based on this result, the processor 301 may implement the interference mitigation by adjusting the operating frequency of the RFI generating device to minimize interference while maintaining optimal system performance. The processor 301 may determine the result by correlating the utilization state with operating frequency information stored in the memory 302. The processor 301 may analyze whether the wireless communication link requires prioritization due to high data throughput or predetermined sensitive operations like real-time video streaming.

Alternatively, or additionally, if the wireless communication link is idle or lightly loaded, the processor 301 may prioritize the RFI generating device's operations for purposes such as memory performance optimization, in which the processor 301 may instruct the RFI generating device to operate with an operating frequency having an overlapped configuration with the radio frequency channel of the wireless communication link.

For this purpose, the processor 301 may retrieve traffic metrics or activity indicators from the communication interface 303 and compare them against threshold values stored in the memory 302. For example, the processor 301 may calculate the traffic volume on the wireless communication link and evaluate whether the RFI generating device's operating frequency should be adjusted to avoid interference. The memory 302 may include thresholds for determination of active and/or inactive states and the processor 301 may correlate them with operational priorities.

In an example, the processor 301 may adjust the operating frequency of the RFI generating device only if the utilization state of the wireless communication link is representative of an active state. If the wireless communication link is inactive, the processor 301 may refrain from adjusting the operating frequency, thereby optimizing other system parameters such as power efficiency. The processor 301 may receive activity updates from the communication interface 303 and compare them against predefined thresholds stored in the memory 302 as described herein. The memory 302 may also store configurations defining active and inactive states for various link types, enabling the processor 301 to make informed decisions. Preceding operations may involve real-time monitoring of the communication link and identifying whether the link qualifies as active or inactive. Essential aspects include activity monitoring and threshold-based decision-making.

In an example, the processor 301 may determine the utilization state of the wireless communication link based on a received signal strength indicator (RSSI) of the wireless communication link. The RSSI value, as received by the communication interface 303, may provide an indication of the signal quality and strength associated with the wireless communication link. For instance, higher RSSI values may indicate a stronger and more stable link, whereas lower values may suggest potential degradation. The processor 301 may compare the RSSI values against predefined signal quality thresholds stored in the memory 302. Based on this comparison, the processor 301 may adjust the operating frequency of the RFI generating device to ensure that interference is minimized during low RSSI scenarios. The processor 301 may also utilize RSSI trends over time to predict and preemptively mitigate interference. Essential aspects include RSSI monitoring and mapping RSSI ranges to interference mitigation policies.

In an example, the processor 301 may obtain network usage data from at least one of an 802.11-based network driver, a cellular network driver, or an Ethernet network driver to determine the utilization state. These drivers may provide insights into data throughput, signal quality, and activity status for their respective links. For instance, the Wi-Fi driver may report metrics such as channel utilization, while the Ethernet driver may provide data transfer rates. The processor 301 may retrieve this network usage data via the communication interface 303 and use the data for its analysis of the utilization state. Based on this analysis, the processor 301 may adjust the operating frequency of the RFI generating device to align with the network's operational requirements. Essential aspects include integrating driver-reported metrics and correlating them with interference mitigation policies stored in the memory 302.

In an example, the processor 301 may determine a priority value associated with each of the Wi-Fi, cellular, and Ethernet drivers and adjust the operating frequency of the RFI generating device based on the priority value and the utilization state of the wireless communication link. For instance, the processor 301 may assign higher priority to links supporting critical operations, such as video conferencing on Wi-Fi, compared to background updates on cellular. The processor 301 may utilize priority tables stored in the memory 302 to assign and compare these priority values dynamically.

In an example, the processor 301 may detect a change in the radio frequency channel of the wireless communication link and adjust the operating frequency of the RFI generating device in response. This detection may involve monitoring channel changes reported by the communication interface 303, such as during a channel handoff in Wi-Fi or a frequency adjustment in cellular networks. The processor 301 may cross-reference the new channel information with interference patterns stored in the memory 302 and instruct the RFI generating device to operate at a frequency that minimizes overlap.

In an example, the processor 301 may adjust the operating frequency of the RFI generating device based on a comparison of memory utilization and network utilization thresholds. For instance, if memory utilization exceeds a predefined threshold while network utilization remains low, the processor 301 may prioritize memory operations by optimizing the operating frequency of the RFI generating device, illustratively by instructing the RFI generating device to operate at the operating frequency that overlaps with the radio frequency channel of the wireless communication link. In an example, the RFI generating device may include a memory device configured to operate with a double data rate. This configuration may provide higher performance for memory operations, particularly during interference mitigation scenarios. The processor 301 may ensure that the RFI generating device operates at frequencies compatible with the double data rate mode, minimizing interference while maximizing memory throughput. The memory 302 may store performance profiles for the double data rate configuration, enabling the processor 301 to dynamically optimize the operating frequency of the RFI generating device. Essential aspects include compatibility with double data rate operation and the integration of performance profiles into interference mitigation strategies.

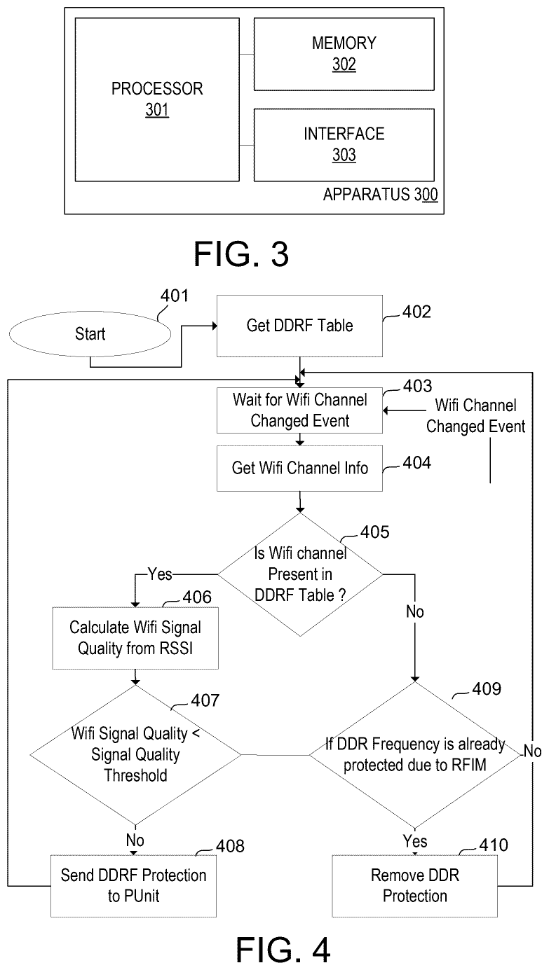

FIG. 4 shows an example of a flow diagram in accordance with various aspects described herein. In an example a processor (e.g. the processor 301) may perform operations to for the implementation of the flow diagram. It is to be noted that the flow diagram has been presented for illustrative example with respect to a scenario in which the RFI generating device is a DDR memory device and the wireless communication link includes a Wi-Fi link. The processor 301 may correspondingly adjust the protection based on Wi-Fi channel information (i.e. radio frequency channel of the link), DDRF table data (i.e. operating frequency information), and signal quality assessments.

In 401, the RFI mitigation implementation is initialized. The processor 301 may prepare for RFI mitigation management operations by initializing its subsystems, including accessing the memory 302 for stored configurations and operational thresholds. It may also activate communication protocols with the communication interface 303 to monitor Wi-Fi channels, which may illustratively be implemented during device boot-up.

In 402, the processor 301 may obtain the operating frequency information, which is illustrated as DDRF table. The processor may retrieve the DDRF table from memory 302. This table may map DDR operating frequencies to potential interference with radio frequency channels. The processor 301 may access the memory 302 to load the DDRF table, which includes predefined configurations of DDR rates and their corresponding RF channel interference patterns. As illustrated herein before, the DDRF table may list specific DDR frequencies (e.g., 2600 MT/s, 5200 MT/s) and associated Wi-Fi channels in the 5 GHz and 6 GHz bands.

In 403, the processor 301 may wait for a change event associated with the wireless communication link, such as Wi-Fi channel changed event. The processor 301 may monitor the communication interface 303 for any Wi-Fi channel change events. The processor 301 may configure event listeners within the communication interface 303 to detect real-time channel change notifications, which may include monitoring management frames in Wi-Fi communications. Illustratively, if the wireless communication device moves to a new location, causing a Wi-Fi channel handoff, the processor 301 may detect the event and begin the process of interference mitigation.

In 404, the processor 301 may obtain information representing the radio frequency channel of the wireless communication link, illustratively with get Wi-Fi channel info. For example, upon detecting a channel change, the processor 301 may retrieve updated information about the new Wi-Fi channel. The processor 301 may query the communication interface 303 to obtain details about the active channel, such as its center frequency and bandwidth. Illustratively, for a channel change to 40 MHz bandwidth in the 5 GHz band, the processor 301 may extract these parameters for comparison with the DDRF table.

In 405, the processor 301 may check if the radio channel frequency of the link is present in the operating frequency information, illustratively with is Wi-Fi channel present in DDRF table. The processor 301 may determine whether the active Wi-Fi channel matches any entry in the DDRF table. Using a lookup algorithm, the processor 301 may cross-reference the channel information from block 404 with the entries in the DDRF table stored in memory 302. Illustratively, if the active channel is 36 in the 5 GHz band and the DDRF table indicates potential interference with DDR rates above 5200 MT/s, the processor 301 may identify this as a match.

In 406, the processor 301 may determine a metric for the link, illustratively by calculating Wi-Fi signal quality from RSSI. If the channel is present in the DDRF table, the processor 301 may evaluate the Wi-Fi signal quality based on RSSI. The processor 301 may calculate signal quality metrics using data from the communication interface 303. These metrics may include comparisons to predefined thresholds stored in memory 302. Illustratively, for an RSSI of −65 dBm, the processor 301 may classify the signal as below optimal quality, triggering interference mitigation.

In 407, the processor 301 may determine whether the metric exceeds a threshold, illustratively by determining if Wi-Fi Signal Quality<Signal Quality Threshold. The processor 301 may compare the calculated Wi-Fi signal quality with a predefined threshold. The processor 301 may retrieve the threshold value from memory 302 and may perform a comparison operation. Illustratively, if the threshold is-60 dBm and the calculated signal quality is-65 dBm, the processor 301 determines that interference mitigation is required.

In 408, the processor 301 may instruct a power management controller (e.g. the PMC 218) to initiate the interference mitigation by changing and/or setting the operating frequency of the RFI generating device, illustratively via send DDRF protection to PMC 218. If the signal quality is below the threshold, the processor 301 may instruct the PMC to enable DDRF protection. The processor 301 may send control signals to the PMC, specifying the DDR frequencies to avoid, based on the DDRF table and current Wi-Fi channel information. Illustratively, for a channel in the 6 GHz band, the processor 301 may instruct the PMC to avoid DDR frequencies above 6000 MT/s.

In 409, the processor 301 may determine if DDR frequency is already protected due to interference mitigation. For example, if the Wi-Fi signal quality is acceptable or the channel is not present in the DDRF table, the processor 301 may checks if DDRF protection is already active. The processor 301 may query the PMC to determine the current status of DDRF protection and evaluate whether it aligns with the interference mitigation policies. For example, the processor 301 may verify that DDR protection for certain frequencies was activated during a previous event.

In 410, the processor 301 may determine to remove the interference mitigation, illustratively via remove DDR protection. If interference mitigation is active but unnecessary, the processor 301 may instruct the PMC to remove it. The processor 301 may send commands to the PMC to disable DDRF protection for specific frequencies, optimizing performance while ensuring minimal interference. Illustratively, if the device switches to an Ethernet connection or the Wi-Fi link is idle, the processor 301 deactivates DDR protection to improve memory throughput.

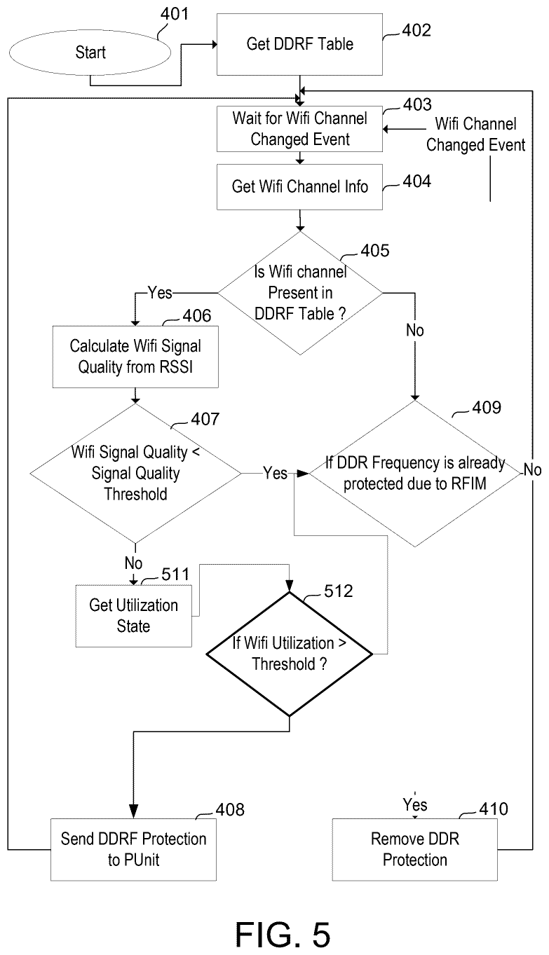

FIG. 5 shows an example of a flow diagram in accordance with various aspects described herein. In an example a processor (e.g. the processor 301) may perform operations to for the implementation of the flow diagram. It is to be noted that the flow diagram has been presented for illustrative example with respect to a scenario in which the RFI generating device is a DDR memory device and the wireless communication link includes a Wi-Fi link. The processor 301 may correspondingly adjust the protection based on Wi-Fi channel information (i.e. radio frequency channel of the link), DDRF table data (i.e. operating frequency information), and signal quality assessments. It is further to be noted that the flow diagram includes blocks that are identical to corresponding blocks with identical reference numbers which are also identical in operation as well. Hence those blocks are not described in accordance with FIG. 5 for brevity.

As illustrated in FIG. 5, the flow diagram includes blocks 511 and 512. In 511, the processor 301 may determine a utilization state, illustratively via get utilization state. This block may introduce an additional decision point in the process flow by incorporating the utilization state of the Wi-Fi link, which may ensure that interference mitigation decisions (e.g., DDRF protection) are informed not only by signal quality but also by the extent to which the Wi-Fi link is actively utilized. The utilization state may represent metrics such as data traffic volume, throughput, and activity status of the Wi-Fi link as described herein.

The processor 301 may retrieve real-time metrics related to the utilization state from the communication interface 303. The communication interface 303 may provide information such as packet counters, data rates, or activity status. The processor 301 may compare these metrics to predefined thresholds stored in memory 302 to quantify the utilization state. The processor 301 may integrate utilization metrics into its interference mitigation algorithm so that decisions may consider both signal quality (from block 406) and network usage. The processor 301 may compare utilization metrics against thresholds defined in memory 302. For example, if the utilization state indicates a data throughput of 50 Mbps, and the threshold for active utilization is set to 40 Mbps, the processor 301 may classify the link as highly utilized (i.e. active). The communication interface 303 may monitor events such as the initiation of high-bandwidth activities (e.g., video streaming) or low-priority usage (e.g., background updates). The processor may process these events 301 to calculate the utilization state. For example, when the Wi-Fi link is streaming high-definition video, the utilization state may exceed the threshold, prompting interference mitigation actions. Additionally, or alternatively, if the wireless communication device is idle or engaged in low-priority tasks, the utilization state may remain below the threshold, allowing the processor 301 to deprioritize interference management.

In 512, the processor 301 may perform the above-mentioned comparison with if Wi-Fi utilization>threshold to evaluate whether the current utilization state of the Wi-Fi link exceeds a predefined threshold. The processor 301 may determine whether DDRF protection should be activated or deactivated based on network activity levels. Illustratively, the processor 301 may compare the calculated utilization state against a predefined threshold stored in memory 302. If the utilization state exceeds the threshold, the processor 301 may continue the interference mitigation process (leading to block 408). If not, the processor 301 may evaluate other conditions or terminate mitigation actions.

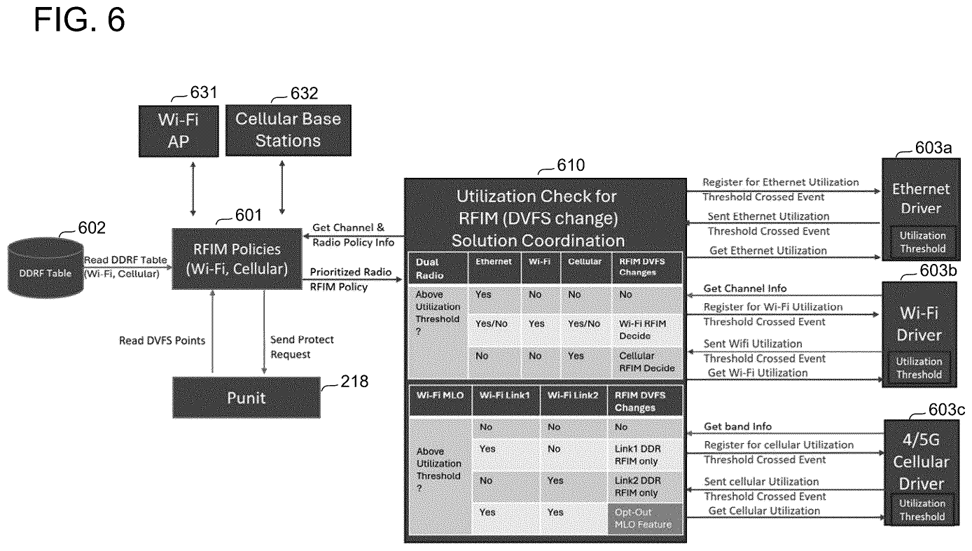

FIG. 6 shows an example of a block diagram illustrating interference management in accordance with various aspects described herein. Illustratively, a wireless communication device (e.g. communication device 200 including the apparatus 300) may implement the interference management, which the wireless communication device may include multiple interfaces and communicate via multiple established wireless communication links. Each component of the diagram may be described along with its function, operation, and implementation by a processor (e.g., processor 301) of the wireless communication device in an illustrative case of the RFI generating device including a DDR memory device.

The interference management may include operating frequency information, including a DDRF table representing a memory-based data structure stored in the memory 302 of the wireless communication device. This table may hold information representing predefined mappings of DDR operating frequencies and their potential interference with radio frequency channels used by wireless communication links, such as Wi-Fi and cellular networks.

The processor 301 may be configured to access the DDRF Table (e.g. Read DDRF table) to retrieve information regarding frequency configurations that are susceptible to interference. This table may serve as the basis for the RF interference management (RFIM) policies. The processor 301 may read this table periodically or in response to network events to decide whether to enable or disable interference mitigation measures. For example, when the Wi-Fi driver 603b provide information related to utilization state of the Wi-Fi link, such as a threshold-crossing event, the processor 301 may, based on the DDRF Table, determine whether the current DDR operating frequency overlaps with the RF channel. Additionally, or alternatively, the DDRF Table may include dynamic entries updated based on real-time data collected by the processor 301, such as the utilization state of wireless links.

The processor 301 may implement RFIM policies 601. In this illustrative example, this block may be deemed to represent the RFIM policies for Wi-Fi and cellular radio links. The processor 301 may implement the RFIM policies as software components configured to mitigate interference by adjusting system settings, such as dynamic voltage and frequency scaling (DVFS) points of the DDR memory. Illustratively, the processor 601 may read DVFS points to determine the current operating frequency of the DDR memory device through the PMC 218 and/or send protection request to instruct interference mitigation (e.g. adjust the operating frequency or instruct to operate with a designated operating frequency).

In some examples, the processor 301 may retrieve RFIM policies from the memory 302 and implement them based on the detected utilization states of the established wireless links. For example, the processor 301 may retrieve channel information from the Wi-Fi driver 603b and cellular driver 603c to determine which radio link should be prioritized. Based on this prioritization, the processor 301 may send protect requests to the PMC 218, instructing the PMC to avoid specific DVFS points listed in the RFIM policies.

The processor 301 may, via the RFIM policies, also coordinate interference mitigation across multiple radio links. In one example, if the Wi-Fi utilization exceeds a threshold while the cellular link is idle, the processor 301 may prioritize protecting the Wi-Fi channel and correspondingly instruct the PMC to cause the DDR memory device to operate with an operation frequency that does not overlap with the Wi-Fi channel. Conversely, if both links are active, the policies may dictate balanced mitigation strategies.

The PMC (depicted as Punit) may serve as the hardware entity (e.g. a controller) that implements changes to the operating frequencies of the DDR memory or other RFI generating device components. The processor 301 may interact with the PMC 218 by sending protect requests, which may specify the DVFS points to be avoided based on the RFIM policies and DDRF Table. For instance, if the processor 301 detects that the cellular link is operating on a channel overlapping with a high-frequency DDR mode, the processor 301 may instruct the PMC 218 to adjust the operating frequency to a safer range that does not overlap with the channel of the cellular link. The PMC 218 may execute these adjustments in real time to ensure impact on the performance.

Illustratively, the PMC 218 may, based on the instructions of the processor 301, may instruct the controller of the DDR memory to operate at a designated operating frequency indicated by the specified DVFS points. The adjustment of the operating frequency may include indicating DVFS points that are different (distinct) from currently set DVFS points. The controller of the DDR may send frequency change commands through an interface between the controller and the memory unit (e.g. DRAM). Illustratively, this interface may include a DDR physical interface (e.g. DFI).

Blocks 603a-c may represent interface of the processor 301 to the communication interface including respective hardware and software components of respective Ethernet, Wi-Fi, and cellular communication. Each driver 603a-c may facilitate communication with its corresponding interface and provides utilization data to the processor 301.

Illustratively, the Ethernet driver may monitor the utilization of wired network connections and inform the processor 301 about threshold-crossing events. If the Ethernet utilization exceeds a predefined threshold, the processor 301 may prioritize Ethernet over wireless links by deactivating RFIM policies for idle wireless links. For example, when a high-throughput file transfer is initiated over Ethernet, the processor 301 may suspend interference mitigation for the Wi-Fi link, allowing the DDR memory to operate at its highest frequency. For this purpose, the processor 301 may register utilization check functions for ethernet utilization via one or more threshold crossed events, instruct the Ethernet driver 603a to get ethernet utilization related information and receive ethernet utilization related information according to one or more threshold crossed events.

The Wi-Fi driver 603b may collect metrics such as channel utilization, RSSI, and throughput. The processor 301 may use this information to assess whether the Wi-Fi link requires interference mitigation. If the utilization exceeds a threshold, the processor 301 may activate RFIM policies to protect the Wi-Fi link. In a multi-link Wi-Fi operation, such as with Wi-Fi 7 or 8, the Wi-Fi driver 603b may provide separate metrics for each link (e.g., Link1 and Link2). The processor 301 may evaluate these metrics independently and adjusts the DDR frequencies accordingly, as illustrated in the table under block 610. For this purpose, the processor 301 may register utilization check functions for Wi-Fi utilization via one or more threshold crossed events, instruct the Wi-Fi driver 603b to get Wi-Fi utilization related information and receive Wi-Fi utilization related information according to one or more threshold crossed events. Furthermore, the processor 301 may further receive channel information representing current and/or scheduled radio frequency channel of the Wi-Fi link or links.

The cellular driver 603c may provide metrics related to cellular network utilization, such as signal strength and data throughput. Similar to the Wi-Fi driver 603b, the cellular driver 603c may inform the processor 301 about threshold-crossing events. Based on this data, the processor 301 may decide whether to activate interference mitigation for the cellular link. For example, during a video call over a 5G connection, the processor 301 may prioritize the cellular link by instructing the PMC 218 to avoid DDR frequencies overlapping with the cellular RF channel. For this purpose, the processor 301 may register utilization check functions for cellular utilization via one or more threshold crossed events, instruct the cellular driver 603c to get cellular utilization related information and receive cellular utilization related information according to one or more threshold crossed events. Furthermore, the processor 301 may further receive band information representing current and/or scheduled radio frequency band of the cellular link or links.

It is to be noted that blocks 631 and 632 may represent further communication devices 631, 632 having established wireless communication links (e.g. Wi-Fi link, cellular link) with the wireless communication device. For example, these blocks may represent external devices, such as a Wi-Fi access point 631 or cellular base station 632 used for data communication, with which the wireless communication device establishes links. The processor 301 may communicate with these devices indirectly through the drivers and interfaces (603b, 603c). By monitoring link conditions, the processor 301 may ensure that interference mitigation measures align with the requirements of the connected devices.

The processor 301 may implement utilization check 610 for RFIM including various aspects described herein with respect to and related to the utilization state. Table described in 610 may illustrate the decision-making process for interference mitigation across different use cases performed by the processor 301. The table is divided into two sections: one for dual-radio configurations (e.g., Ethernet, Wi-Fi, and cellular) and another for multi-link Wi-Fi configurations.

In dual-radio scenarios, the processor 301 may evaluate the utilization thresholds of Ethernet, Wi-Fi, and cellular links. In this illustrative example, if Ethernet utilization exceeds the respective threshold, the processor 301 may prioritize Ethernet by disabling RFIM policies for wireless links, illustratively by instructing the PMC 218 to operate in an operating frequency with a selection of having the most performance out of the DDR memory device. Illustratively, even the Wi-Fi and/or cellular links are configured for a frequency channel within 6 GHz band that overlaps with a possible operating frequency of the DDR memory device, the processor 301 may instruct the PMC 218 to operate with an operating frequency that overlaps with the frequency channel.

If Wi-Fi or cellular utilization exceeds their respective thresholds, the processor 301 may activate RFIM policies to protect the prioritized link. The prioritized link may correspond to a predefined selection among Wi-Fi or cellular, or may correspond to a dynamic selection based on the current utilization state of the links.

In multi-link Wi-Fi configurations, such as Wi-Fi multi-link operation, the processor 301 may evaluate the utilization of each link (e.g., Link1 and Link2). The table specifies the RFIM DVFS changes for each scenario: If Link1 utilization exceeds the threshold, the processor 301 may activate DDR protection for Link1 only, in which the operating frequency is configured not to overlap with the radio frequency of Link 1. If both links are above the threshold, the processor 301 may opt out of the MLO feature to prevent interference on both links.

The processor may implement these decisions by coordinating with the PMC 218 and the respective drivers 603a-c. For example, in a high-utilization scenario involving Link1 and Link2, the processor may dynamically adjust the DDR frequencies to avoid overlapping with the RF channels used by both links.

In an illustrative flow, the processor may retrieve the DDRF Table 602 and utilization data from the Ethernet 603a, Wi-Fi 603b, and cellular 603c drivers. The processor 301 may evaluate the utilization thresholds for each interface, as defined in block 610. Based on the evaluation, the processor 301 may activate RFIM policies through the PMC 218. The PMC 218 may adjust the DDR frequencies to align with the RFIM policies. The processor 301 may continuously monitor utilization states and updates the RFIM policies as conditions change.

Correspondingly, the wireless communication device may establish communication with the Wi-Fi, cellular, and wire Ethernet drivers to retrieve network data utilization. The RFIM policies may be configured for dual radios and may be based on separate DDRF Tables and policies for each Wi-Fi and cellular, respectively. Through aspects described herein, the processor 301 may detect the presence of both wire and wireless network drivers and monitor for events indicating network usage is above or below a specified threshold when each network driver is accessible and retrieve network usage data from all activated network drivers. The processor 301 may further activate the RFIM policies of DVFS point protection according to the RFIM solution sharing definition, for example when network usage exceeds the predetermined threshold. Furthermore, the processor 301 may remove any existing RFIM protection when Wi-Fi and cellular usages fall below the threshold.

In various examples, the wireless communication device may establish communication with the Wi-Fi, cellular, and wire Ethernet drivers to retrieve network data utilization. The RFIM policies may be configured for dual radios and may be based on separate DDRF Tables and policies for each Wi-Fi and cellular, respectively. The processor 301 may detect the presence of both wire and wireless network drivers and monitor for events indicating network usage is above or below a specified threshold when each network driver is accessible and retrieve network usage data from all activated network drivers. The processor 301 may activate the RFIM policies of DVFS point protection according to the RFIM solution sharing definition, especially when network usage exceeds the predetermined threshold. The processor 301 may remove any existing RFIM protection when Wi-Fi and cellular usages fall below the threshold. When Wi-Fi MLO feature is activated, the processor 301 may not opt-out the feature even with the presence of double RFIs on both links. Instead the processor 301 may check the network usage on both links and initiate proper RFIM solution according to the definition.

As previously stated, the RFI generating device may be designed to operate at alternative operating points (voltage/frequency) to balance the power and performance. The PMC 218 can use alternative operating points to avoid RFI. As an example, a DDR memory device design may include dynamic voltage and frequency scaling (DVFS) which is a modern PC feature to balance the power consumption (lowest frequency) and the performance (highest frequency). The following example relates to a Wi-Fi communication, but it should be noted that the methods and concepts may be applied to other communication technologies such as Bluetooth, or cellular (e.g. wireless wide area network (WWAN), ultrawideband (UWB)), or other wireless communication devices impacted by RFI.

DDR may be designed with specific DVFS points to avoid generating RFI impacting wireless communication devices. Alternate DDR DVFS points may be optimized for radio communications but may not be optimal for the memory device's performance if requests for alternating DVFS points are frequent. The alternate DVFS points may be predefined and chosen to move the DDR data rates into a different frequency to avoid RFI to the wireless channel frequency band in use or designated for future use. At the same time, the alternative DVFS point may alter power supply voltage level for power and performance optimizations. Ideally, the change results in minimal performance degradation of the memory device and minimum power consumption tradeoff.

An example of alternate rate points for a platform, include a LPDDR5 memory device and wireless network interface card (WNIC) radio communication device. The DVFS point primary data rate (502) for the memory device is LP5-6400. The DVFS point alternate data rate (504) for a memory device is LP5-6200. In this example, the platform may support 6 GHz Wi-Fi up to 160 MHz bandwidth channels. A memory device operating at a primary data rate of LP5-6400 may generate RFI which interferes with the wireless communication. RFI around 6400 MHz, which may include a −0.5% spread spectrum clock effect, could impact Wi-Fi channels 85, 89, 93, 83, 91, 87 or 79 of the 6 GHz band. Changing the data rate to 6200 MT/s will clear those Wi-Fi channels for communication and eliminate generating RFI at the wireless communication device operating frequency. The change from 6200 MT/s is a minimal deviation from 6400 MT/s to clear the Wi-Fi channels from RFI noise. If the WNIC operation at the Wi-Fi channels ceases, the DDR memory device may resume operation at 6400 MT/s.

In an example, the memory device may be configured with one alternate point, illustratively a DVFS model with four points. Each DVFS point includes a primary rate. If necessary, an alternate rate may be defined for a DVFS point. For example, DVFS point includes a primary rate at 6400 MT/s and an alternate rate at 5200 MT/s. Other DVFS points are not interfering in the Wi-Fi operation band; therefore, no alternative point is assigned. But if the DVFS point must be allocated at a frequency that will cause interference in the Wi-Fi band, an alternative point can be utilized to avoid RFI.

The alternate rate of DDR LP5-6200 represents a 3.125% DDR reduction in speed at certain period of time (not all the times). This results in significantly lower performance impact than a static solution. It should be noted that other RFI generating devices may include DVFS or other RFI avoidance techniques. Correspondingly, the adjusting of an operating frequency may correspond to changing DVFS points, which may include changing a DVFS point into a further DVFS point that may also be an alternative point.

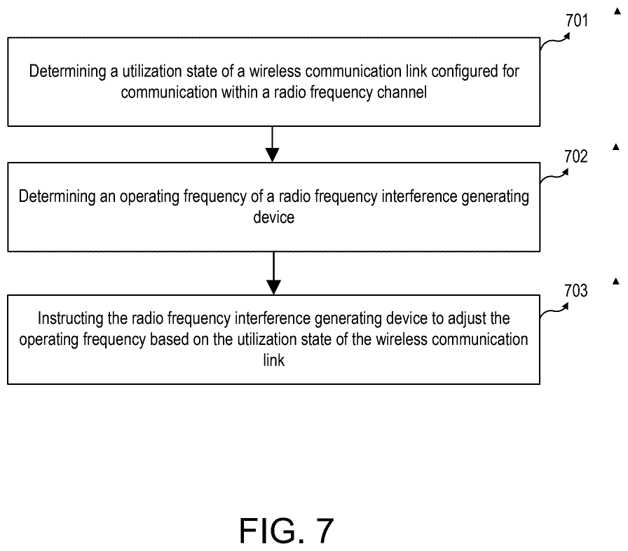

FIG. 7 shows an example of a method. The method may include: determining 701 a utilization state of a wireless communication link configured for communication within a radio frequency channel; determining 702 an operating frequency of a radio frequency interference generating device; and instructing 703 the radio frequency interference generating device to adjust the operating frequency based on the utilization state of the wireless communication link.

The following examples pertain to further aspects.
Example 1 may include a subject matter including an apparatus including: a memory, and a processor configured to: determine a utilization state of a wireless communication link configured for communication within a radio frequency channel; determine an operating frequency of a radio frequency interference generating device; and instruct the radio frequency interference (RFI) generating device to adjust the operating frequency based on the utilization state of the wireless communication link.
Example 2 may include the subject matter of example 1, wherein the processor is configured to determine or adjust the operating frequency based on operating frequency information associated with the RFI generating device stored in the memory.
Example 3 may include the subject matter of example 1 or example 2, wherein the processor is configured to instruct the RFI generating device to adjust the operating frequency if the operating frequency has been configured to overlap with the radio frequency channel.
Example 4 may include the subject matter of any one of examples 1 to 3, wherein the processor is configured to instruct the RFI generating device to operate with the operating frequency if the utilization state of the wireless communication link is representative of an inactive state.
Example 5 may include the subject matter of any one of examples 1 to 4, wherein the utilization state includes a metric representative of data traffic via the wireless communication link; wherein the processor is configured to instruct the RFI generating device to determine the operating frequency based on the metric and a data traffic threshold.
Example 6 may include the subject matter of example 5, wherein the operating frequency is adjusted if the metric representative of data traffic exceeds the data traffic threshold; and/or wherein the operating frequency is maintained if the metric representative of data traffic is below the data traffic threshold.
Example 7 may include the subject matter of any one of examples 1 to 6, wherein the processor is configured to determine the utilization state by monitoring the wireless communication link for events representing a usage of a network connected via the wireless communication link.
Example 8 may include the subject matter of any one of examples 1 to 7, wherein the utilization state is a first utilization state and the wireless communication link is a first wireless communication link; wherein the processor is further configured to determine a second utilization state of a second wireless communication link; wherein the processor is further configured to instruct the RFI generating device to operate at the operating frequency further based on the second utilization state.
Example 9 may include the subject matter of example 8, wherein the first wireless communication link includes a link of an IEEE 802.11 based communication and the second wireless communication link includes a link of a cellular communication.
Example 10 may include the subject matter of example 8, wherein the first wireless communication link and the second wireless communication link are IEEE 802.11 based communication links for a multi-link operation.
Example 11 may include the subject matter of any one of examples 8 to 10, wherein the radio frequency channel is a first radio frequency channel and the second wireless communication link is configured for communication within a second radio frequency channel; wherein the processor is configured to select the first wireless communication link or the second wireless communication link for data communication based on the first radio frequency channel, the second radio frequency channel, and the operating frequency of the RFI generating device.
Example 12 may include the subject matter of any one of examples 8 to 11, wherein the processor is configured to determine the operating frequency based on the first radio frequency channel and the second radio frequency channel during a dual-radio concurrent operation.
Example 13 may include the subject matter of any one of examples 1 to 12, wherein the processor is configured to determine a result representative of whether to prioritize an operation of the RFI generating device or an operation of the wireless communication link based on the utilization state; wherein the processor is configured to implement an RFI management policy including adjusting the operation frequency of the RFI generating device based on the result.
Example 14 may include the subject matter of any one of examples 1 to 13, wherein the utilization state includes information representing whether the wireless communication link is active or inactive, and wherein the processor is configured adjust the operating frequency of the RFI generating device only if the wireless communication link is active.
Example 15 may include the subject matter of any one of examples 1 to 14, wherein the processor is configured to determine the utilization state of the wireless communication link based on a Received Signal Strength Indicator (RSSI) of the wireless communication link.
Example 16 may include the subject matter of any one of examples 1 to 15, wherein the processor is configured to obtain network usage data from at least one of a 802.11 based network driver, a cellular network driver, or an Ethernet network driver to determine the utilization state.
Example 17 may include the subject matter of example 16, wherein the processor is configured to: determine a priority value associated with each of the Wi-Fi, cellular, and Ethernet drivers, and adjust the operating frequency of the radio frequency interference generating device based on the priority value and the utilization state of the wireless communication link.
Example 18 may include the subject matter of any one of examples 1 to 17, wherein the processor is configured to detect a change in the radio frequency channel of the wireless communication link and adjust the operating frequency of the radio frequency interference generating device in response to the detected change.
Example 19 may include the subject matter of any one of examples 1 to 18, wherein the processor is further configured to adjust the operating frequency of the radio frequency interference generating device based on a comparison of memory utilization and network utilization thresholds.
Example 20 may include the subject matter of any one of examples 1 to 19, wherein the RFI generating device includes a memory device configured to operate with a double data rate.
Example 21 may include a subject matter including a method including: determining a utilization state of a wireless communication link configured for communication within a radio frequency channel; determining an operating frequency of a radio frequency interference generating device; and instructing the radio frequency interference (RFI) generating device to adjust the operating frequency based on the utilization state of the wireless communication link.
Example 22 may include the subject matter of example 21, may further include determining or adjusting the operating frequency based on operating frequency information associated with the RFI generating device stored in a memory.
Example 23 may include the subject matter of example 21 or example 22, may further include instructing the RFI generating device to adjust the operating frequency if the operating frequency has been configured to overlap with the radio frequency channel.
Example 24 may include the subject matter of any one of examples 21 to 23, may further include instructing the RFI generating device to operate with the operating frequency if the utilization state of the wireless communication link is representative of an inactive state.
Example 25 may include the subject matter of any one of examples 21 to 24, wherein the utilization state includes a metric representative of data traffic via the wireless communication link, and may further include instructing the RFI generating device to determine the operating frequency based on the metric and a data traffic threshold.
Example 26 may include the subject matter of example 25, may further include: adjusting the operating frequency if the metric representative of data traffic exceeds the data traffic threshold; and/or maintaining the operating frequency if the metric representative of data traffic is below the data traffic threshold.
Example 27 may include the subject matter of any one of examples 21 to 26, may further include determining the utilization state by monitoring the wireless communication link for events representing a usage of a network connected via the wireless communication link.
Example 28 may include the subject matter of any one of examples 21 to 27, wherein the utilization state is a first utilization state and the wireless communication link is a first wireless communication link, the method may further include: determining a second utilization state of a second communication link; and instructing the RFI generating device to operate at the operating frequency further based on the second utilization state.
Example 29 may include the subject matter of example 28, wherein the first wireless communication link includes a link of an IEEE 802.11 based communication, and the second wireless communication link includes a link of a cellular communication.
Example 30 may include the subject matter of example 28, wherein the first wireless communication link and the second wireless communication link are IEEE 802.11 based communication links for a multi-link operation.
Example 31 may include the subject matter of any one of examples 28 to 30, wherein the radio frequency channel is a first radio frequency channel, and the second wireless communication link is configured for communication within a second radio frequency channel, and may further include selecting the first wireless communication link or the second wireless communication link for data communication based on the first radio frequency channel, the second radio frequency channel, and the operating frequency of the RFI generating device.
Example 32 may include the subject matter of any one of examples 28 to 31, may further include determining the operating frequency based on the first radio frequency channel and the second radio frequency channel during a dual-radio concurrent operation.
Example 33 may include the subject matter of any one of examples 21 to 32, may further include: determining a result representative of whether to prioritize an operation of the RFI generating device or an operation of the wireless communication link based on the utilization state; and implementing an RFI management policy including adjusting the operating frequency of the RFI generating device based on the result.
Example 34 may include the subject matter of any one of examples 21 to 33, wherein the utilization state includes information representing whether the wireless communication link is active or inactive, and may further include adjusting the operating frequency of the RFI generating device only if the wireless communication link is active.
Example 35 may include the subject matter of any one of examples 21 to 34, may further include determining the utilization state of the wireless communication link based on a Received Signal Strength Indicator (RSSI) of the wireless communication link.
Example 36 may include the subject matter of any one of examples 21 to 35, may further include obtaining network usage data from at least one of an 802.11 based network driver, a cellular network driver, or an Ethernet network driver to determine the utilization state.
Example 37 may include the subject matter of example 36, may further include: determining a priority value associated with each of the Wi-Fi, cellular, and Ethernet drivers; and adjusting the operating frequency of the radio frequency interference generating device based on the priority value and the utilization state of the wireless communication link.
Example 38 may include the subject matter of any one of examples 21 to 37, may further include detecting a change in the radio frequency channel of the wireless communication link and adjusting the operating frequency of the radio frequency interference generating device in response to the detected change.
Example 39 may include the subject matter of any one of examples 21 to 38, may further include adjusting the operating frequency of the radio frequency interference generating device based on a comparison of memory utilization and network utilization thresholds.
Example 40 may include the subject matter of any one of examples 21 to 39, wherein the RFI generating device includes a memory device configured to operate with a double data rate.
Example 41 may include a subject matter including a non-transitory computer-readable medium including instructions which, when executed by a processor, cause the processor to: determine a utilization state of a wireless communication link configured for communication within a radio frequency channel; determine an operating frequency of a radio frequency interference generating device; and instruct the radio frequency interference (RFI) generating device to adjust the operating frequency based on the utilization state of the wireless communication link.
Example 42 may include the subject matter of example 41, including instructions to cause the processor to determine or adjust the operating frequency based on operating frequency information associated with the RFI generating device stored in a memory.
Example 43 may include the subject matter of example 41 or example 42, including instructions to cause the processor to instruct the RFI generating device to adjust the operating frequency if the operating frequency has been configured to overlap with the radio frequency channel.
Example 44 may include the subject matter of any one of examples 41 to 43, including instructions to cause the processor to instruct the RFI generating device to operate with the operating frequency if the utilization state of the wireless communication link is representative of an inactive state.
Example 45 may include the subject matter of any one of examples 41 to 44, wherein the utilization state includes a metric representative of data traffic via the wireless communication link, and including instructions to cause the processor to instruct the RFI generating device to determine the operating frequency based on the metric and a data traffic threshold.
Example 46 may include the subject matter of example 45, including instructions to cause the processor to: adjust the operating frequency if the metric representative of data traffic exceeds the data traffic threshold; and/or maintain the operating frequency if the metric representative of data traffic is below the data traffic threshold.
Example 47 may include the subject matter of any one of examples 41 to 46, including instructions to cause the processor to determine the utilization state by monitoring the wireless communication link for events representing a usage of a network connected via the wireless communication link.
Example 48 may include the subject matter of any one of examples 41 to 47, wherein the utilization state is a first utilization state and the wireless communication link is a first wireless communication link, and including instructions to cause the processor to: determine a second utilization state of a second wireless communication link; and instruct the RFI generating device to operate at the operating frequency further based on the second utilization state.
Example 49 may include the subject matter of example 48, wherein the first wireless communication link includes a link of an IEEE 802.11 based communication, and the second wireless communication link includes a link of a cellular communication.
Example 50 may include the subject matter of example 48, wherein the first wireless communication link and the second wireless communication link are IEEE 802.11 based communication links for a multi-link operation.
Example 51 may include the subject matter of any one of examples 48 to 50, wherein the radio frequency channel is a first radio frequency channel, and the second wireless communication link is configured for communication within a second radio frequency channel, and including instructions to cause the processor to select the first wireless communication link or the second wireless communication link for data communication based on the first radio frequency channel, the second radio frequency channel, and the operating frequency of the RFI generating device.
Example 52 may include the subject matter of any one of examples 48 to 51, including instructions to cause the processor to determine the operating frequency based on the first radio frequency channel and the second radio frequency channel during a dual-radio concurrent operation.
Example 53 may include the subject matter of any one of examples 41 to 52, including instructions to cause the processor to: determine a result representative of whether to prioritize an operation of the RFI generating device or an operation of the wireless communication link based on the utilization state; and implement an RFI management policy including adjusting the operating frequency of the RFI generating device based on the result.
Example 54 may include the subject matter of any one of examples 41 to 53, wherein the utilization state includes information representing whether the wireless communication link is active or inactive, and including instructions to cause the processor to adjust the operating frequency of the RFI generating device only if the wireless communication link is active.
Example 55 may include the subject matter of any one of examples 41 to 54, including instructions to cause the processor to determine the utilization state of the wireless communication link based on a Received Signal Strength Indicator (RSSI) of the wireless communication link.
Example 56 may include the subject matter of any one of examples 41 to 55, including instructions to cause the processor to obtain network usage data from at least one of an 802.11 based network driver, a cellular network driver, or an Ethernet network driver to determine the utilization state.
Example 57 may include the subject matter of example 56, including instructions to cause the processor to: determine a priority value associated with each of the Wi-Fi, cellular, and Ethernet drivers; and adjust the operating frequency of the radio frequency interference generating device based on the priority value and the utilization state of the wireless communication link.
Example 58 may include the subject matter of any one of examples 41 to 57, including instructions to cause the processor to detect a change in the radio frequency channel of the wireless communication link and adjust the operating frequency of the radio frequency interference generating device in response to the detected change.
Example 59 may include the subject matter of any one of examples 41 to 58, including instructions to cause the processor to adjust the operating frequency of the radio frequency interference generating device based on a comparison of memory utilization and network utilization thresholds.
Example 60 may include the subject matter of any one of examples 41 to 59, wherein the RFI generating device includes a memory device configured to operate with a double data rate.

The words “plurality” and “multiple” in the description or the claims expressly refer to a quantity greater than one. The terms “group (of)”, “set [of]”, “collection (of)”, “series (of)”, “sequence (of)”, “grouping (of)”, etc., and the like in the description or in the claims refer to a quantity equal to or greater than one, i.e. one or more. Any term expressed in plural form that does not expressly state “plurality” or “multiple” likewise refers to a quantity equal to or greater than one.

Any vector and/or matrix notation utilized herein is exemplary in nature and is employed solely for purposes of explanation. Accordingly, the apparatuses and methods described herein accompanied by vector and/or matrix notation are not limited to being implemented solely using vectors and/or matrices, and that the associated processes and computations may be equivalently performed with respect to sets, sequences, groups, etc., of data, observations, information, signals, samples, symbols, elements, etc.

As used herein, “memory” is understood as a non-transitory computer-readable medium in which data or information can be stored for retrieval. References to “memory” included herein may thus be understood as referring to volatile or non-volatile memory, including random access memory (“RAM”), read-only memory (“ROM”), flash memory, solid-state storage, magnetic tape, hard disk drive, optical drive, etc., or any combination thereof. Furthermore, registers, shift registers, processor registers, data buffers, etc., are also embraced herein by the term memory. A single component referred to as “memory” or “a memory” may be composed of more than one different type of memory, and thus may refer to a collective component including one or more types of memory. Any single memory component may be separated into multiple collectively equivalent memory components, and vice versa. Furthermore, while memory may be depicted as separate from one or more other components (such as in the drawings), memory may also be integrated with other components, such as on a common integrated chip or a controller with an embedded memory.

The term “software” refers to any type of executable instruction, including firmware.

In the context described herein, the term “process” may be used, for example, to indicate a method. Illustratively, any process described herein may be implemented as a method (e.g., a channel estimation process may be understood as a channel estimation method). Any process described herein may be implemented as a non-transitory computer readable medium including instructions configured, when executed, to cause one or more processors to carry out the process (e.g., to carry out the method).

Throughout the drawings, it should be noted that like reference numbers are used to depict the same or similar elements, features, and structures, unless otherwise noted. It should be noted that certain components may be omitted for the sake of simplicity.

The phrase “at least one” and “one or more” may be understood to include a numerical quantity greater than or equal to one (e.g., one, two, three, four, [ . . . ], etc.). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, [ . . . ], etc.).

As used herein, a signal or information that is “indicative of”, “representative”, “representing”, or “indicating” a value or other information may be a digital or analog signal that encodes or otherwise, communicates the value or other information in a manner that can be decoded by and/or cause a responsive action in a component receiving the signal. The signal may be stored or buffered in computer-readable storage medium prior to its receipt by the receiving component and the receiving component may retrieve the signal from the storage medium. Further, a “value” that is “indicative of” or “representative” some quantity, state, or parameter may be physically embodied as a digital signal, an analog signal, or stored bits that encode or otherwise communicate the value.

As used herein, a signal may be transmitted or conducted through a signal chain in which the signal is processed to change characteristics such as phase, amplitude, frequency, and so on. The signal may be referred to as the same signal even as such characteristics are adapted. In general, so long as a signal continues to encode the same information, the signal may be considered as the same signal. For example, a transmit signal may be considered as referring to the transmit signal in baseband, intermediate, and radio frequencies.

The terms “processor” or “controller” as, for example, used herein may be understood as any kind of technological entity that allows handling of data. The data may be handled according to one or more specific functions executed by the processor. Further, a processor or controller as used herein may be understood as any kind of circuit, e.g., any kind of analog or digital circuit. A processor or a controller may thus be or include an analog circuit, digital circuit, mixed-signal circuit, logic circuit, processor, microprocessor, central processing unit, graphics processing unit, digital signal processor, field programmable gate array, integrated circuit, application specific integrated circuit, etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

The terms “one or more processors” is intended to refer to a processor or a controller. The one or more processors may include one processor or a plurality of processors. The terms are simply used as an alternative to the “processor” or “controller”.

The term “user device” is intended to refer to a device of a user (e.g. occupant) that may be configured to provide information related to the user. The user device may exemplarily include a mobile phone, a smart phone, a wearable device (e.g. smart watch, smart wristband), a computer, etc.

As utilized herein, terms “module”, “component,” “system,” “circuit,” “element,” “slice,” “circuit,” and the like are intended to refer to a set of one or more electronic components, a computer-related entity, hardware, software (e.g., in execution), and/or firmware. For example, circuit or a similar term can be a processor, a process running on a processor, a controller, an object, an executable program, a storage device, and/or a computer with a processing device. By way of illustration, an application running on a server and the server can also be circuit. One or more circuits can reside within the same circuit, and circuit can be localized on one computer and/or distributed between two or more computers. A set of elements or a set of other circuits can be described herein, in which the term “set” can be interpreted as “one or more”.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and represent any information as understood in the art. The term “data item” may include data or a portion of data.

It will be understood that when an element is referred to as being “connected” or “coupled” to another element, it can be physically connected or coupled to the other element such that current and/or electromagnetic radiation (e.g., a signal) can flow along a conductive path formed by the elements. Inherently, such element is connectable or couplable to the another element. Intervening conductive, inductive, or capacitive elements may be present between the element and the other element when the elements are described as being coupled or connected to one another. Further, when coupled or connected to one another, one element may be capable of inducing a voltage or current flow or propagation of an electro-magnetic wave in the other element without physical contact or intervening components. Further, when a voltage, current, or signal is referred to as being “provided” to an element, the voltage, current, or signal may be conducted to the element by way of a physical connection or by way of capacitive, electro-magnetic, or inductive coupling that does not involve a physical connection.

Unless explicitly specified, the term “instance of time” refers to a time of a particular event or situation according to the context. The instance of time may refer to an instantaneous point in time, or to a period of time which the particular event or situation relates to.

Unless explicitly specified, the term “transmit” encompasses both direct (point-to-point) and indirect transmission (via one or more intermediary points). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as RF transceivers and antennas, and the logical transmission and reception over the software-level connection is performed by the processors or controllers. The term “communicate” encompasses one or both of transmitting and receiving, i.e., unidirectional or bidirectional communication in one or both of the incoming and outgoing directions. The term “calculate” encompasses both ‘direct’ calculations via a mathematical expression/formula/relationship and ‘indirect’ calculations via lookup or hash tables and other array indexing or searching operations.

While the above descriptions and connected figures may depict electronic device components as separate elements, skilled persons will appreciate the various possibilities to combine or integrate discrete elements into a single element. Such may include combining two or more circuits to form a single circuit, mounting two or more circuits onto a common chip or chassis to form an integrated element, executing discrete software components on a common processor core, etc. Conversely, skilled persons will recognize the possibility to separate a single element into two or more discrete elements, such as splitting a single circuit into two or more separate circuits, separating a chip or chassis into discrete elements originally provided thereon, separating a software component into two or more sections and executing each on a separate processor core, etc.

It is appreciated that implementations of methods detailed herein are demonstrative in nature, and are thus understood as capable of being implemented in a corresponding device. Likewise, it is appreciated that implementations of devices detailed herein are understood as capable of being implemented as a corresponding method. It is thus understood that a device corresponding to a method detailed herein may include one or more components configured to perform each aspect of the related method. All acronyms defined in the above description additionally hold in all claims included herein.

What is claimed is:

1. An apparatus comprising:
a memory, and
a processor configured to:
determine a utilization state of a wireless communication link configured for communication within a radio frequency channel;
determine an operating frequency of a radio frequency interference (RFI) generating device; and
instruct the RFI generating device to adjust the operating frequency based on the utilization state of the wireless communication link.

2. The apparatus of claim 1, wherein the processor is configured to determine or adjust the operating frequency based on operating frequency information associated with the RFI generating device stored in the memory.

3. The apparatus of claim 1, wherein the processor is configured to instruct the RFI generating device to adjust the operating frequency if the operating frequency has been configured to overlap with the radio frequency channel.

4. The apparatus of claim 1, wherein the processor is configured to instruct the RFI generating device to operate with the operating frequency if the utilization state of the wireless communication link is representative of an inactive state.

5. The apparatus of claim 1, wherein the utilization state comprises a metric representative of data traffic via the wireless communication link; and
wherein the processor is configured to instruct the RFI generating device to determine the operating frequency based on the metric and a data traffic threshold.

6. The apparatus of claim 5, wherein the operating frequency is maintained if the metric representative of data traffic is below the data traffic threshold.

7. The apparatus of claim 1, wherein the processor is configured to determine the utilization state by monitoring the wireless communication link for events representing a usage of a network connected via the wireless communication link.

8. The apparatus of claim 1, wherein the utilization state is a first utilization state and the wireless communication link is a first wireless communication link;
wherein the processor is further configured to determine a second utilization state of a second wireless communication link; and
wherein the processor is further configured to instruct the RFI generating device to operate at the operating frequency further based on the second utilization state.

9. The apparatus of claim 8, wherein the first wireless communication link comprises a link of an IEEE 802.11 based communication and the second wireless communication link comprises a link of a cellular communication.

10. The apparatus of claim 8, wherein the first wireless communication link and the second wireless communication link comprises IEEE 802.11 based communication links for a multi-link operation.

11. The apparatus of claim 8, wherein the radio frequency channel is a first radio frequency channel and the second wireless communication link is configured for communication within a second radio frequency channel; and
wherein the processor is configured to select the first wireless communication link or the second wireless communication link for data communication based on the first radio frequency channel, the second radio frequency channel, and the operating frequency of the RFI generating device.

12. The apparatus of claim 11, wherein the processor is configured to determine the operating frequency based on the first radio frequency channel and the second radio frequency channel during a dual-radio concurrent operation.

13. The apparatus of claim 1, wherein the processor is configured to determine a result representative of whether to prioritize an operation of the RFI generating device or an operation of the wireless communication link based on the utilization state; and
wherein the processor is configured to implement an RFI management policy comprising adjusting the operation frequency of the RFI generating device based on the result.

14. The apparatus of claim 1, wherein the utilization state comprises information representing whether the wireless communication link is active or inactive, and wherein the processor is configured adjust the operating frequency of the RFI generating device only if the wireless communication link is active.

15. The apparatus of claim 1, wherein the processor is further configured to adjust the operating frequency of the RFI generating device based on a comparison of memory utilization and network utilization thresholds.

16. The apparatus of claim 1, wherein the RFI generating device comprises a memory device configured to operate with a double data rate.

17. A wireless communication device comprising:
a radio frequency interference (RFI) generating device; and
an apparatus comprising:
a memory, and
a processor configured to:
determine a utilization state of a wireless communication link configured for communication within a radio frequency channel;
determine an operating frequency of the radio frequency interference generating device; and
instruct the RFI generating device to adjust the operating frequency based on the utilization state of the wireless communication link.

18. The wireless communication device of claim 17; further comprising a power management controller configured to control the operating frequency of the RFI generating device.

19. A non-transitory computer-readable medium comprising instructions which, if executed by a processor, cause the processor to:
determine a utilization state of a wireless communication link configured for communication within a radio frequency channel;
determine an operating frequency of a radio frequency interference (RFI) generating device; and
instruct the RFI generating device to adjust the operating frequency based on the utilization state of the wireless communication link.

20. The non-transitory computer-readable medium of claim 19, wherein the instructions further cause the processor to determine or adjust the operating frequency based on operating frequency information associated with the RFI generating device stored in a memory.
